(19) United States
(12) Patent Application Publication
(10) Pub. No.: US 2021/0175721 A1
(43) Pub. Date: Jun. 10, 2021

(54) SYSTEMS, METHODS, APPARATUSES, AND DEVICES FOR PROVIDING AN ELECTRICAL POWER TO AN ELECTRICAL LOAD

(71) Applicant: Raymond Edward Berry, Louisville, KY (US)

(72) Inventor: Raymond Edward Berry, Louisville, KY (US)

(21) Appl. No.: 17/117,071

(22) Filed: Dec. 9, 2020

Related U.S. Application Data
(60) Provisional application No. 62/945,740, filed on Dec. 9, 2019.

(51) Int. Cl. H02J 3/38; F03D 9/25; F03D 3/04; F03D 9/45; F03D 9/11; H02K 7/18; H02J 7/00

(52) U.S. Cl. CPC H02J 3/381; F03D 9/25; F03D 3/0418; F03D 9/45; H02J 2300/28; H02K 7/183; H02J 7/0048; F05B 2220/706; F05B 2260/42; F03D 9/11

(57) ABSTRACT

Disclosed herein is a wind-based power plant system for providing an electrical power to an electrical load, in accordance with some embodiments. Accordingly, the wind-based power plant system may include a building structure, a wind directing assembly, a turbine blade assembly, and an electrical generator. Further, the wind directing assembly controls and creates a flow of wind. Further, the wind directing assembly comprises a wind sensor, a processing device, and an actuator. Further, the wind sensor generates wind data based on a direction and a velocity of the wind. Further, the processing device analyzes the wind data and generates a command. Further, the actuator transitions the wind directing assembly between wind directing states based on the command. Further, wind turbine blades of the turbine blade assembly rotate around a vertical axis of the building structure based on the flow of the wind. Further, the electrical generator generates the electrical power.

The current application claims a priority to the U.S. provisional patent application Ser. No. 62/945,740 filed on Dec. 9, 2019.

### FIELD OF THE INVENTION

Generally, the present disclosure relates to the field of static structures. More specifically, the present disclosure relates to systems, methods, apparatuses, and devices for providing an electrical power to an electrical load. The electrical load can be, but is not limited to, a microgrid, a macrogrid (e.g. a power plant for a city area), or any other sized grid.

### BACKGROUND OF THE INVENTION

In a recent report over 100 environmental scientists stated that the world must stop releasing massive amounts of Co2 into the air by 2030, or there could be irreversible damage done to the earth. None of the existing technologies solve all the problems with electricity production. Currently, the most affordable and consistent power generating technologies are coal and natural gas power plants. However, they must burn coal and gas to rotate their turbines, which emits Co2 into the air and causes air pollution. Some byproducts come from the transport, preparation, and burning of coal and gas that does not exist. The other current renewable technologies such as wind, solar, geothermal, and hydro either do not produce enough power or they are not completely reliable. None of these technologies are cost effective and all of them have a high Levelized Cost of Electricity (LCOE).

Most of the residents of the world are in favor of transferring from fuel burning technologies to clean renewable technologies. This is a complicated issue due to the cost and the effect it would have on most economies around the world. If the United States were to attempt to switch to completely clean electricity production immediately, the construction cost would be in the trillions and the monthly cost for electricity to consumers would increase significantly. It would be a devastating setback to the US economy and no generation so far has been willing to endure this transition.

Currently, the most likely technologies to be used to convert the world to renewable energy are solar fields and traditional wind farms. Both of these technologies consume massive amounts of land and ruin the landscape. If we were to replace all the coal and natural gas plants with wind turbines and solar panels most of the vacant land outside of the cities would need to be populated with wind turbines and solar panels. Everywhere we look we will see these monstrosities such as from expressways, high rise buildings, beaches, and hiking trails. We will be solving one problem and creating another one.

Therefore, there is a need for improved systems, methods, apparatuses, and devices for providing an electrical power to an electrical load that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a wind-based power plant system for providing an electrical power to an electrical load, in accordance with some embodiments. Accordingly, the wind-based power plant system may include a building structure, at least one wind directing assembly, at least one turbine blade assembly, and at least one electrical generator. Further, the building structure may be vertically erectable on a surface. Further, the building structure may include at least one housing structure. Further, the at least one housing structure may be vertically stacked for forming the building structure. Further, the at least one wind directing assembly may be disposed in the at least one housing structure. Further, a wind directing assembly of the at least one wind directing assembly disposed in a housing structure of the at least one housing structure may be configured for allowing entering of wind in the housing structure from a first side of the housing structure. Further, the wind directing assembly may be configured for allowing exiting of the wind from a second side of the housing structure. Further, the wind directing assembly may be configured for at least one of controlling and creating a flow of the wind based on at least one of the allowing entering of the wind and the allowing exiting of the wind. Further, the wind directing assembly may be transitionable between a plurality of wind directing states of the wind directing assembly for the at least one of the allowing entering of the wind and the allowing exiting of the wind. Further, the wind directing assembly may include at least one wind sensor, a processing device, and at least one actuator. Further, the at least one wind sensor may be disposed in the housing structure. Further, the at least one wind sensor may be configured for generating at least one wind data based on at least one of a direction of the wind and a velocity of the wind associated with the housing structure. Further, the processing device may be communicatively coupled with the at least one wind sensor. Further, the processing device may be configured for analyzing the at least one wind data. Further, the processing device may be configured for generating a command based on the analyzing. Further, the at least one actuator may be disposed in the housing structure. Further, the at least one actuator may be operationally coupled with the wind directing assembly. Further, the at least one actuator may be communicatively coupled with the processing device. Further, the at least one actuator may be configured for transitioning the wind directing assembly between the plurality of wind directing states of the wind directing assembly based on the command. Further, the at least one turbine blade assembly may be disposed in the at least one housing structure. Further, a turbine blade assembly of the at least one turbine blade assembly disposed in the housing structure may include a plurality of wind turbine blades arranged radially around a vertical axis of the building structure in the housing structure. Further, the plurality of wind turbine blades may be configured for intercepting the flow of the wind. Further, the plurality of wind turbine blades may be configured for rotating around the vertical axis based on the intercepting. Further, the at least one electrical generator may be disposed in the at least one housing structure. Further, the at least one electrical generator may be mechanically coupled with the at least one turbine blade assembly. Further, an electrical generator of the at least one electrical generator disposed in the housing structure may be configured for generating the electrical power based on the rotating. Further, the at least one electrical generator may be electrically couplable to the electrical load for providing the electrical power to the electrical load.

Further disclosed herein is a wind-based power plant system for providing an electrical power to an electrical load, in accordance with some embodiments. Accordingly, the wind-based power plant system may include a building structure, at least one wind directing assembly, at least one turbine blade assembly, at least one electrical generator, and a power storage system. Further, the building structure may be vertically erectable on a surface. Further, the building structure may include at least one housing structure. Further, the at least one housing structure may be vertically stacked for forming the building structure. Further, the at least one wind directing assembly may be disposed in the at least one housing structure. Further, a wind directing assembly of the at least one wind directing assembly disposed in a housing structure of the at least one housing structure may be configured for allowing entering of wind in the housing structure from a first side of the housing structure. Further, the wind directing assembly may be configured for allowing exiting of the wind from a second side of the housing structure. Further, the wind directing assembly may be configured for at least one of controlling and creating a flow of the wind based on at least one of the allowing entering of the wind and the allowing exiting of the wind. Further, the wind directing assembly may be transitionable between a plurality of wind directing states of the wind directing assembly for the at least one of the allowing entering of the wind and the allowing exiting of the wind. Further, the wind directing assembly may include at least one wind sensor, a processing device, and at least one actuator. Further, the at least one wind sensor may be disposed in the housing structure. Further, the at least one wind sensor may be configured for generating at least one wind data based on at least one of a direction of the wind and a velocity of the wind associated with the housing structure. Further, the processing device may be communicatively coupled with the at least one wind sensor. Further, the processing device may be configured for analyzing the at least one wind data. Further, the processing device may be configured for generating a command based on the analyzing. Further, the at least one actuator may be disposed in the housing structure. Further, the at least one actuator may be operationally coupled with the wind directing assembly. Further, the at least one actuator may be communicatively coupled with the processing device. Further, the at least one actuator may be configured for transitioning the wind directing assembly between the plurality of wind directing states of the wind directing assembly based on the command. Further, the at least one turbine blade assembly may be disposed in the at least one housing structure. Further, a turbine blade assembly of the at least one turbine blade assembly disposed in the housing structure may include a plurality of wind turbine blades arranged radially around a vertical axis of the building structure in the housing structure. Further, the plurality of wind turbine blades may be configured for intercepting the flow of the wind. Further, the plurality of wind turbine blades may be configured for rotating around the vertical axis based on the intercepting. Further, the at least one electrical generator may be disposed in the at least one housing structure. Further, the at least one electrical generator may be mechanically coupled with the at least one turbine blade assembly. Further, an electrical generator of the at least one electrical generator disposed in the housing structure may be configured for generating the electrical power based on the rotating. Further, the at least one electrical generator may be electrically couplable to the electrical load for providing the electrical power to the electrical load. Further, the power storage system may be electrically coupled with the at least one electrical generator. Further, the power storage system may include at least one battery. Further, the at least one battery may be configured for receiving the electrical power from the at least one electrical generator. Further, the at least one battery stores the electrical power based on the receiving. Further, the electrical power may include a DC electrical power. Further, the power storage system may be electrically couplable to the electrical load for providing the electrical power to the electrical load.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a wind-based power plant system for providing an electrical power to an electrical load, in accordance with some embodiments.

FIG. 3 is a block diagram of the at least one wind directing assembly of the wind-based power plant system, in accordance with some embodiments.

FIG. 4 is a block diagram of the wind-based power plant system with the power storage system, in accordance with some embodiments.

FIG. 5 is a block diagram of the power storage system of the wind-based power plant system, in accordance with some embodiments.

FIG. 6 is a block diagram of the power storage system with the at least one battery charging assembly, in accordance with some embodiments.

FIG. 7 is a block diagram of the at least one wind directing assembly with the at least one sensor, in accordance with some embodiments.

FIG. 8 is a block diagram of the wind-based power plant system with the power storage system and the at least one power production generator assembly, in accordance with some embodiments.

FIG. 9 is a block diagram of the at least one wind directing assembly with the at least one velocity sensor, in accordance with some embodiments.

FIG. 10 is a block diagram of the at least one wind directing assembly with the at least one electrical power measuring device, in accordance with some embodiments.

FIG. 11 is a block diagram of the wind-based power plant system with the turbine velocity control system, in accordance with some embodiments.

FIG. 12 is a block diagram of the turbine velocity control system of the wind-based power plant system, in accordance with some embodiments.

FIG. 13 is a block diagram of the at least one wind directing assembly with the at least one environment sensor, in accordance with some embodiments.

FIG. 14 is a block diagram of the at least one wind directing assembly with the at least one measuring device, in accordance with some embodiments.

FIG. 15 is a block diagram of a wind-based power plant system for providing an electrical power to an electrical load, in accordance with some embodiments.

FIG. 16 is a block diagram of the at least one wind directing assembly of the wind-based power plant system, in accordance with some embodiments.

FIG. 17 is a block diagram of the power storage system of the wind-based power plant system, in accordance with some embodiments.

FIG. 18 is a block diagram of the power storage system with the at least one battery charging assembly, in accordance with some embodiments.

FIG. 19 is a block diagram of a wind-based power plant system for providing an electrical power to an electrical load, in accordance with some embodiments.

FIG. 21 is a front view of the wind-based power plant system for providing the electrical power to the electrical load, in accordance with some embodiments.

FIG. 22 is a top view of the turbine blade assembly of the wind-based power plant system, in accordance with some embodiments.

FIG. 23 is a perspective view of the turbine blade assembly of the wind-based power plant system, in accordance with some embodiments.

FIG. 24 is a perspective view of the battery power storage system, in accordance with some embodiments.

FIG. 25 is a cross-sectional view of the power production generator assembly, in accordance with some embodiments.

FIG. 26 is a front view of the wind-based power plant system in a city landscape, in accordance with some embodiments.

FIG. 27 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems, methods, apparatuses, and devices for providing an electrical power to an electrical load, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g.

username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes systems, methods, apparatuses, and devices for providing an electrical power to an electrical load. Further, the present disclosure describes a wind-based power plant building structure that can provide low cost zero emissions electricity to consumers. Further, the wind-based power plant building structure may include a Vertical Imaginary Axis Wind Turbines (VIAWT). The reason the axis is imaginary is that the Wind Turbine Blades of Vertical Imaginary Axis Wind Turbines do not converge at a central point requiring an actual vertical axis shaft.

Further, the wind-based power plant building structure looks like a circular shaped high-rise office tower, except that most every floor above a certain level houses a large donut shaped wind turbine known as the VIAWT, that consumes approximately 60% of the outer portion of the structure. The radial wind turbines have a vertical imaginary axis and are rotated when controllable wind vanes on the exterior of the building allow the wind to enter the building and rotate them. The wind turbines are connected to off-the-shelf or proprietary generators that either send power directly to the grid or to battery chargers that charge a bank (or banks) of batteries located in or near the power plant building.

The charged batteries power off-the-shelf or proprietary motors that rotate off-the-shelf or proprietary generators located on the same level as the turbine or in other buildings that may have turbines or may not have turbines. The result will be a system of creating wind based, clean, and zero emissions electricity to power cities and microgrids anywhere in the world, regardless of the amount of wind or wind speed at the location of the power plant. Unlike other turbines, these turbines will rotate in light wind because they have a vertical axis, which orientates the turbines horizontal to the earth's gravity. The wind turbine blades will be lightweight because they are fully supported by a low-friction magnetic bearing wheel and frame system (and will not need to carry their own weight). Therefore, it is expected that in most locations there will be enough wind to keep the batteries adequately charged to meet the demand power load at all times. However, there could be places or times of the year when there is not enough wind to adequately charge the batteries to meet the demand load or be ready to serve the anticipated demand load. When it is anticipated that the amount of electricity generated by the power plant will not be able to meet the demand load, fully charged batteries from a master charging plant or another power plant can be brought to the site and added to the system. This procedure ensures that the plant will always meet the demand load and produce electricity even when the wind is too low to keep the batteries charged or in periods of dead calm. It is also possible to have power plants with no turbines that run solely on charged batteries brought in from other locations.

It is difficult to compare the VIAWT technology to a typical horizontal axis wind turbine (HAWT) farms because they are different in almost every way. Horizontal axis wind farms consume hundreds and thousands of acres of land. The wind-based power plant building structure using stacked VIAWT technology can optimally be located on approximately 5-acres of land and can be creatively situated on a city block. One full-size, 36 turbine power Plant is projected to produce enough power to support a small to medium sized city depending on the number of stacked turbines and the final results of finite engineering. One of the largest traditional wind farms in the United States is called Roscoe and it consumes 100,000 acres of land. Roscoe has 664 horizontal axis wind turbines and it can produce 781.5 megawatts per hour. By comparison, a single power plant building will consume about 5-acres and is estimated to produce 0.5 to 7 times as much electricity. The Roscoe wind farm cost over $1 billion dollars to construct, plus the cost of leasing the land every month. The wind-based power plant building structure will be much less expensive to construct, will produce more power per dollar of investment, with no monthly land lease fees. Additionally, traditional wind turbine farms must be located away from the cities because they are loud and unsightly. Whereas, the Berry Power Plants will be aesthetically pleasing works of art that can be located in the city or anywhere within the local power grid, where the greatest need for electricity exists. Further, the present disclosure describes a wind-based power plant building shell.

Further, the wind-based power plant building shell may take the form of various configurations. Further, the wind-based power plant building shell may take the form of a dedicated building shell suited for urban environments. Further, the wind-based power plant building shell may take the form of any building shell design suited for various landscapes, settings, foundations, or any other suitable setting. Further, the wind-based power plant building shell provides low cost and zero emissions electricity to consumers. A plurality of floors of the power plant building starting with the first may be used as a base to elevate the wind turbine floors above the scouring height of the wind. These floors can be used for numerous purposes. Potentially, some or all of the lower floors will be used to house offices to support the power plant operations. The way the power plant will generate electricity is by allowing the wind to enter the building through operable wind vanes causing the VIAWT wind turbine assemblies (WTA) inside the building to rotate. Further, all power plant structural framing systems will be designed to withstand hurricanes and other high wind and pressure events as well as seismic activity to the extent any high-performance high-rise building would be expected to perform. Further, the power plant building shell comprises a nacelle chassis, a wind vane assembly, a wind funnel intake ring, a turbine blade assembly, a battery charging system, a battery power storage system, a power production generator assembly, an alternate small power production generator assembly, a turbine velocity control system and a plant management system. Starting at a height where the wind velocity is optimal there will be a plurality of stacked wind turbine levels. A common large power plant configuration may have 3 banks of 12 wind turbine levels. There will likely be intermediate floors in between each bank of wind turbine levels that could house a plurality of batteries. These intermediate floors may have balconies around the building that are used for in-house observation and maintenance. The level that is above the top turbine in the building (as well as just below any completely solid intermediate level) could have a powered exhaust system around the perimeter to maintain low pressure through the potentially open vertical cylinder. The upper floors above the turbine banks may be used for multiple purposes such as meeting spaces, an observation deck, or other uses that could be integrated. Each turbine level will have a center area called the nacelle. The nacelle will likely have two or more stairs and one or more elevators. The nacelle may have a place where someone could sit while troubleshooting or managing the wind turbine assemblies (WTA) and the generator assemblies (GA). The exterior of the building will have operable wind vane assemblies (WVA) that open to allow the wind to flow through the structure on the positive side of the building and be released out on the back side. As the wind passes through the building it puts the wind turbines in motion. The turbines are connected to gear assemblies that rotate the battery charging generators (BCG) or in some cases the generators being directly rotated by the turbines may be producing the sellable electricity. Further, the charged batteries are connected to motors that rotate off-the-shelf or proprietary generators. The generators have rotors comprising a plurality of alternating pairs of magnets. When the alternating magnetic fields pass through magnetic stators with magnetic copper windings alternating electricity is produced. Some of the electricity produced will be used to provide power for the power plant site and the building itself. The remaining electricity will be sent from the power plant to a local substation for demand load distribution on the local grids, and any surplus can be provided to the high voltage grid. Some of the electricity above the demand load can be used to recharge the battery banks. Further, the nacelle is the circular area in the center of the building. Further, the nacelle houses a plurality of fire rated exit stairs and a plurality of elevators. The elevators may be passenger elevators, freight elevators, and/or mobile offices. The elevators will likely need to transport replacement parts and components of the turbine and generator assemblies after the building is constructed. One or more elevators may be quite large to accommodate this capability. There will be a wall between the wind turbine assemblies to allow the nacelle to be conditioned space. One or more off-the-shelf or proprietary generators will be housed in the nacelle where it's dry and temperature and humidity can be controlled. The nacelle will provide a staging platform for observation and maintenance of the system. Further, the wind vane assemblies (WVA) comprise the exterior 360-degree plurality of vertical or horizontal axis operable panels called “wind vanes”. These panels makeup the exterior skin of the building for all levels that house wind turbine assemblies. The purpose of the wind vanes is to allow wind to enter the building and cause the wind turbines to rotate (when open) or prevent wind from entering the building, thus making the turbines not rotate (when closed). This level of control provides a distinct advantage over other wind-based turbines because the operation computers and personnel will have complete control over the rotation of the wind turbine assemblies. Further, the operations personnel can stop the wind turbine assemblies for inspection or maintenance at any time by closing the wind vane assemblies. The operator can also slow down the rotation of the WTA's by partially closing the wind vanes, which may be necessary if the wind outside the power plant is too strong. Further, the plurality of wind vanes comprises at least one servo motor attached to each individual wind vane or a bank of wind vanes that cause them to open and close. Alternatively, the fixed or controllable wind vanes may be attached to a 360-degree wind shroud. A percentage of the wind vanes would likely be permanently open and the rest would be permanently closed. The number and angle of the open wind vanes would match the optimal location for the wind to be directed at the turbine blades. The entire shroud would rotate to match the direction of the wind rather than opening and closing individually operated wind vanes or banks of wind vanes. To stop the turbines from rotating the shroud would be rotated so that the closed wind vanes are on the front side of the wind and the open wind vanes are on the leeward side of the wind. Unless overridden by the operations personnel, the wind vanes will be opened or closed as directed by a plant management software program (PMSP), which is a component of the plant management system (PMS). One of the many tasks of the PMSP is to open and close certain wind vane assemblies to keep the maximum amount of wind flowing through the building. A plurality of exterior sensors called the exterior conditions sensor system (ECSS) will constantly monitor and send information back to the PMSP regarding the wind azimuth, velocity, and other weather conditions. Based on this information the plant management software program sends directives to the servo motors to fully open, partially open, or close individual wind vanes or banks of wind vanes. In the case of the wind shroud, the software rotates the entire shroud so that the wind vanes are optimally positioned in the direction of the wind. Most of the time the PMSP will instruct the wind vanes to be completely open allowing the maximum amount of wind to enter and exit the building, which will in turn rotate the turbines at maximum velocity and will continue to charge the batteries as rapidly as possible or directly generate sellable electricity. In general, this will be accomplished by the PMSP directing approximately 50% of the wind vanes to be positioned parallel with the wind azimuth on the positive side of each wind turbine. Simultaneously, the PMSP directs the wind vanes on the negative side of the structure to open to full capacity to let wind flow through and out the rear of the building. If the structure of the building has an open frame between each turbine floor then a percentage of the wind may be directed upward into the low-pressure side of the wind turbine blades of the level above but most of the wind will exit the building on the negative side of the wind/building. When the wind azimuth changes, the PMSP will instantly direct the servo motors to adjust the wind vane assemblies to allow the most productive wind flow through the structure, which charges the batteries to the maximum amount possible or generates the maximum output from the generators. The wind vane assemblies may open and close differently on each level to maintain the maximum wind intake at each elevation of the building, therefore the wind vanes may not all be in perfect vertical alignment throughout the entire height of the building at any given time. In the case of the wind shroud, each shroud can be rotated independently or together. If rotated individually the fixed wind vanes may or may not align vertically from one shroud to the next at all times.

As an alternative to using many wind vane assemblies around the outer circumference of the building, a single independent contiguous wind funnel intake ring (WFIR) with a funnel shaped opening that would direct a large amount of wind into the building at each turbine level could be used. An opening on the back side of the wind funnel intake ring would allow the wind to exit the building, creating a wind tunnel effect. The wind funnel intake ring would be controlled by the plant management software program, which would rotate the entire assembly to keep the funnel portion of the assembly optimally positioned in relation to the azimuth of the wind. The PMSP would also open and close the wind funnel intake ring sliding doors that allow the wind to be partially or fully blocked from entering the building. Further, the shape of the funnel portion of the wind funnel intake ring would be as large as possible without interfering with the funnel openings above or below its adjacent levels. The funnel portion of the assembly would be shaped to take advantage of the Bernoulli effect to accelerate the wind entering the building. The wind funnel intake ring could operate independently on each turbine floor, or two turbine floors could be combined to create a single wind funnel intake ring that would have two funnels. This is a logical approach because the turbines are usually designed in pairs and each turbine within the pair rotates in a different direction. Therefore, the funnel portion of the wind funnel intake ring would always optimally be positioned on opposite sides of the wind funnel intake ring from each other, and on different levels. For instance, if the turbine on the first level rotates in a clockwise direction the funnel for the first level will be on the lower left of the wind funnel intake ring. The turbine on the second level would then rotate in a counterclockwise direction and the funnel for that turbine would be on the upper right side of the wind funnel intake ring. Since the vertical distance between the turbines in a pair of turbines would always be relatively close in elevation, the optimal orientation relative to the direction of the wind for both funnel openings would always be the same, except on opposite sides of the building. Each wind funnel intake ring would rest on its own set of bearings, wheels, or a rail system, which could be at the bottom of the wind funnel intake ring or it could be at the top with the wind funnel intake ring being suspended from above. The larger the opening of each funnel the more wind will be captured and directed at each turbine, thus rotating it at a higher rpm. The actual opening into the building would be one level tall and would cut out approximately ¼ of the circumference of the wind funnel intake ring. The outermost funnel portion of the intake opening could be two stories tall, which will increase the volume of wind flowing through each turbine. Each funnel could be taller than the actual opening with the extra extension of the funnel projecting up to the top of the second level. This is possible because the second level of the clockwise side funnel would be blank above the opening. The same would be true for the second funnel of the pair except the opening would be on the upper level and the funnel extension would project downward one level. The extended areas of each funnel would extenuate the Bernoulli effect because a larger area of wind would be captured and funneled through the smaller opening. Further, the plurality of wind funnel intake rings would make up the skin of the building for each turbine level. The WFIR skin could appear as a typical office building with a spandrel window system, except where the openings/funnels are. The funnel portion of the WFIR may have the appearance of the skin of a commercial airliner and may possibly be constructed with the same or a similar material. Alternatively, the entire wind funnel intake ring could be constructed of the same or a similar skin as a commercial airliner. Regardless of what material the WFIR is constructed of, it will be solid for approximately ½ of the circumference of the ring. The remaining portion will have an intake opening that encompasses approximately ¼ of the WFIR (with a funnel apparatus attached to the opening). The WFIR would also have an opening in the rear that consumes the final ¼ circumference of the WFIR to allow the wind to exit the building. There would be doors at the openings that can slide into a closed position and block the wind and weather from entering the building. The plant management software program would control the operation of the doors similar to the description of how the plant management software program controls the wind vane assemblies. Depending on the direction the wind at different heights vertically to the building, the funnels may or may not be in perfect alignment for the entire vertical facade of the building

Further, the turbine blade assembly (TBA) is a vertical radial imaginary axis “donut-shaped” assembly comprised of a plurality of wind turbine blades converging at a continuous radial turbine gear ring (CRTGR) with a fully supported frame (one TBA per floor). The TBA comprises the wind turbine blades, the turbine blade support system (TBSS), CRTGR, and the turbine velocity control system (TVCS). Further, the turbine blade assembly is orientated perpendicular to the earth's gravity similar to a merry-go-round. This allows the assembly to rotate easily because it is not in opposition to gravity. The purpose of the turbine blade assembly is to rotate the generator drive shaft assembly, which is attached to a battery charging generator controller or to off-the-shelf or proprietary primary output generators. The generator drive shaft assembly rotates the battery charging generator controller or primary output generators at the highest rpm's possible to charge the batteries at the maximum rate or to provide the maximum amount of primary power. The turbine blade assembly will be designed to be as light as possible and for its components to have as little friction as possible when put into motion. This will allow the TBA to rotate even when low velocity winds are introduced into the building. Further, the wind turbine blades are aerodynamically designed utilizing an airfoil concept to effectively capture the energy of the wind. Further, the wind turbine blades have some curved and some flat surfaces to utilize lift/drag and high pressure/low pressure to cause the turbines to rotate at maximum speed. The plurality of wind turbine blades will be constructed of a strong non-combustible lightweight material that will not be compromised by strong winds. The plurality of wind turbine blades will likely be assembled in place and can be disassembled in place if they need to be repaired or replaced.

A component of the turbine blade assembly is a turbine blade support system (TBSS) that supports the plurality of wind turbine blades. This frame assembly consists of the continuous radial turbine gear ring (CRTGR) frame. It also includes a plurality of continuous radial support rails that reside to the outside of the CRTGR. These support rails called “tracks” support the wind turbine blades in several locations along the bottom length of the blades. The tracks provide a surface for the turbine blade's “trucks” to ride on and may be part of the building's structural system. With the wind turbine blades being fully supported rather than cantilevered, they can be constructed of lightweight materials. Attached to the bottom of each turbine blade, and in line with the tracks, will be apparatuses called trucks. The trucks are the support mechanism that allows the wind turbine blades to rest on the tracks when not in motion and to ride on the tracks when the wind turbine blades are in motion. The trucks may be a known type of roller systems such as low maintenance bearing wheels with replaceable wear-surface tires, or a custom apparatus. In either case, the trucks will have a low friction connection to the tracks and will make very little noise when they are in motion. As an alternative to truck wheels, there may be a rail system that the wind turbine blades ride on, similar to a high-speed rail train or roller coaster. With all contacts being low friction and the turbine blade assemblies rotating parallel to the earth's gravity the wind turbine assemblies will rotate with minimal force from the wind and will allow momentum to help keep them in motion. Additional support framework and/or stabilizers may be required to stabilize the wind turbine assemblies.

A specially designed structural system will provide support for the building itself and account for the torque imposed on the structural system by the rotation of the wind turbine assemblies. To balance out the torque imposed on the building by the motion of the turbines, the turbines shall be configured in pairs and rotate in alternating directions on each floor. In other words, the 1st turbine may rotate in a clockwise direction and the 2nd turbine will rotate in a counterclockwise direction, etc. Having the turbines in pairs, and the rotation of each pair being in the opposite direction will greatly simplify the structural design of the building. However, some power plants may only have one turbine and the structural system shall be designed to account for the motion of a single turbine power plant.

Further, the CRTGR is a continuous radial gear that is connected to the ends of the wind turbine blades on the interior portion of the blades. It defines the innermost convergence of the wind turbine blades and provides some vertical support for the wind turbine blades. Since the CRTGR is connected to the wind turbine blades it rotates when the wind blade assemblies are rotated by the wind. The purpose of the CRTGR is to drive the generator drive shaft assembly. The CRTGR gears will match up with the bevel gears that drive the DSA.

Further, the turbine velocity control system is managed by the plant management software program. The TVCS consists of a braking and lockout system, a plurality of turbine motors per turbine, and a turbine clutch & gear system (TCGS) for each motor. The turbine motors are connected to the turbines and help start them in motion during startup mode, which is known as the “turbine startup mode”. The motors may also assist the rotation of the turbine assembly when in a mode called the “turbine boost mode”. The turbine assembly will go into turbine boost mode when the wind is too low to efficiently rotate the turbines without mechanical assistance. The motors will be powered by the battery power storage system. The clutch and gear systems provide the connection of the motors to the turbines. The braking and lockout system locks down the turbines to stop them from rotating during maintenance/inspection.

The braking system is used by the plant management software program to stop the turbines or generators from rotating. There will also be a brake button at each turbine and generator as well, allowing a user to stop the rotation at each unit. The turbine assemblies and the generators will have a lockout system that prevents them from rotating during maintenance and inspection. The lockout system will also be used when battery charging is not needed from a particular turbine. The PMSP can also be manually overridden at each assembly and there will be a manual lockout pin that can be inserted to ensure the assemblies cannot start rotating. A braking and lockout system will be required to fully stop and hold the turbines in place. Refer to the plant management software program section regarding additional functionality of the braking & lockout assembly.

The turbine transmission system will operate in a similar fashion to the transmission of a car or truck. The transmission will have a series of gears that start out in low gear to get the turbine in motion and as the rpm of the turbine increases the transmission will shift to higher gears. Once the turbine has momentum and is rotating at or above the speed of the wind the transmission will shift into the optimal gear to match the speed of rotation. The motors will then only need to provide intermittent boosts (boost mode) to keep the turbine rotating at or above the speed determined by the plant management software program. This concept is similar to a car with an automatic transmission traveling on an expressway at 60 mph. The transmission will shift into the optimal gear to lower the RPMs of the motor and use as little fuel as possible. When the turbine is in its optimal gear the occasional boosts will require very little electricity to keep the turbine rotating at the target rpm.

The purpose of the turbine motors is to assist the turbine in startup mode (as described below) when the wind isn't strong enough to start them in rotation by itself, and once they have the momentum to give them occasional boosts to keep them rotating at a higher rpm than the wind can achieve by itself. The electric motors will be off-the-shelf or proprietary motors that are controlled by the plant management software program. The electric turbine motors will be powered by the battery power storage system. Every type of wind turbine in use today requires a minimum wind speed to start it into motion. Horizontal axis wind turbines (HAWT) are the most difficult to get started because they have a cantilevered design similar to a windmill. The wind turbine blades on a HAWT must be very strong and heavy to support their own weight and all the mass and weight is concentrated at one spot in the center of the turbine. These turbines won't even begin to rotate in low to medium winds and once in motion momentum doesn't help them remain in the rotation. The massive 300′ diameter HAWT's are in constant opposition to gravity.

Further, the wind turbines are positioned with a horizontal orientation to gravity, similar to a merry-go-round. The turbines have an imaginary vertical axis rotation point and are fully self-supported, allowing the entire assembly to rotate with little or no resistance. Since the turbines are fully self-supported, are light weight, and are not fighting against gravity, they will have almost zero friction and require very little wind to put them into motion. Once these turbines begin to rotate, they will require very little wind to keep them in motion because they have momentum. This concept is similar to when a car is traveling at 60 mph and the driver only needs to lightly press on the accelerator to keep the car traveling at 60 mph.

Even though the turbines start to rotate and continue to rotate with very little wind, the turbine velocity control system includes a plurality of turbine motors to assist with the startup of the wind turbine assemblies. One or more turbine motors will be positioned around the turbine assembly and will be used to engage with the wind turbine assembly during startup. This assistance will ensure that all turbines achieve rotation equal to or greater than the speed of the wind and achieve momentum immediately, especially when the wind speed is low. Once the wind turbine assemblies have momentum the turbine boost mode can help keep them in motion in times of low wind. The turbine motors will be powered by the batteries in the battery power storage system.

When the wind is blowing but the wind speed is not adequate to rotate the wind turbine assemblies fast enough to adequately charge the batteries, the plant management software program will instruct the turbine velocity control system to engage and to boost the turbines with intermittent assistance. This assistance will work in a similar fashion to the car example where the accelerator is lightly pressed to keep the car traveling at 60 mph. The turbines will still be primarily powered by the wind, but the rpm's will be increased with the intermittent “boosts” from the turbine velocity control system's turbine motors. This concept is similar to a hybrid car that uses gasoline and electricity to power the car, however, this technology is a hybrid system that uses wind and electric motors to rotate the turbines. Within the wind energy engineering community there is a wind efficiency rating factor called the Betz limit, which states that only 59.3% of the kinetic energy of the wind can be harnessed to rotate a wind turbine. This hybrid system of wind and battery power inherent in the disclosed system allows the technology not to be limited to the Betz limit and lessens the possibility that the stored battery power will be depleted.

Further, the battery charging system assembly comprises the drive shaft assembly (DSA), the battery charging generator controller (BCGC), the DC battery charging generator (BCG) (or supercharger), and the battery charging solar farm. The purpose of the drive shaft assembly is to transfer the wind energy to the DC battery charging generators (or superchargers) that charge individual batteries or banks of batteries. The drive shaft assembly connects the continuous radial turbine gear ring to the battery charging generator controller. The drive shaft will have a bevel gear that connects the drive shaft to the CRTGR at one end. On the other end, the DSA will connect to the battery charging generator controller. When the wind turbine assembly is rotated by the wind it will rotate the drive shaft assembly, which causes the battery charging generator controller's gears to rotate, which charges a battery or a bank of batteries, as described in the next section. The shaft will potentially be capable of completely disengaging from the controller's gears. This disengagement may be necessary for testing, maintenance, or other activities. There may be one drive shaft assembly, one controller, and one generator per wind turbine or there may be multiple per turbine.

The battery charging generator controller is driven by the drive shaft assembly as described here. To recap the full sequence of how the battery charging generator controller is rotated; when the turbine blade assembly is rotated by the wind it also rotates the attached continuous radial turbine gear ring, which in turn rotates the drive shaft assembly. The drive shaft assembly is connected to the battery charging generator controllers. The gears inside the battery charging generator controllers will rotate, causing a battery or a bank of batteries to be charged by the DC generator chargers. However, the drive shaft assembly will always rotate at varying RPMs depending on the velocity at which the turbine blade assemblies are being rotated by the wind (or by the wind with assistance from the turbine velocity control system). The generator controllers transfer the drive shaft power to the DC battery charging generator (or supercharger), which charges individual batteries or the “lion's den” battery power storage system.

The DC battery charging generators (BCG) may be off-the-shelf super chargers or proprietary generators that are powered by the drive shaft (which is rotated by the turbines) and associated battery charging controllers. There will be one or more battery charging generators/super chargers per turbine. These charging devices will be connected to individual batteries or the lion's den of batteries. The charged batteries will provide the power required to rotate the main power production generators that create the electricity for the power plant to distribute to the grid.

Further, a battery charging solar farm may be included in some or all of the power plants to assist the wind with charging the batteries. The lion's den battery power storage system will primarily be charged by the wind turbine assemblies but may be supplemented by a solar farm of solar panels. The battery charging solar farm may consist of covered parking structures in the power plant parking lot and/or possibly solar panels on the roofs or solar fields on or near the power plant property. In some locations around the world, a strong wind will be present all the time. In some locations, the wind may not be strong enough to adequately charge the batteries to a level that stays in front of the depletion rate. Supplementing with solar may make up for the inadequacy of the wind (without having to bring in fully charged batteries from other power plants). In other locations, the wind will be lighter during the day and stronger at night when the air is cooler. For these locations, the additional solar farm charging will help keep the batteries adequately charged to stay in front of the demand load.

As an alternative to or in conjunction with the battery charging generators (BCG), there may be off-the-shelf or proprietary direct output generators. These generators would also reside in the nacelle of each turbine level. The drive shaft assemblies may be connected to these direct output generators, which provide power to the microgrid, a local grid of the national grid. Some of the power from these generators may be used to recharge the battery storage system.

Further, the battery power storage system is a bank of battery storage units that are housed in or near the power plant. The individual batteries or banks could be stored on each turbine floor, on any of the non-turbine floors, in a basement area of the building, or even in a separate building outside of the power plant. The primary purpose of the batteries is to power the motors that rotate the power production generators that transmit electricity to the grid. Therefore, the battery power storage system will constantly be in a state of being depleted by the power production generation motors. If the battery power storage system charge level ever runs out the power production generation motors will shut down and the power plant will stop supplying the customers with electricity. These batteries will constantly be recharged using any of the following five methods. In method 1, the wind will rotate the turbine assemblies that will interact with the battery charging generator controller and battery charging generators (or supercharger), which will recharge the batteries. In method 2, the wind, with assistance from the turbine velocity control system will charge the batteries. In method 3, the solar panels in the parking lot, on the property, or on the roof will assist in recharging the batteries. In method 4, the excess power from the main generators over the amount needed to satisfy the demand load from the grid will be used to recharge the batteries. In method 5, an off-the-shelf or proprietary generator or generators are connected directly to the drive shaft assembly and provide power to the microgrid, a local grid, or the national grid. Some of the power may be bled off of this process to charge the batteries.

The goal will be to keep the batteries at close to a full charge all the time, even while they are being depleted by the main power production generators that transmit power to the grid. In locations that are conducive to solar power, the solar panels will help fill the gap for any deficiency with the wind turbines recharging the batteries. Overnight the wind tends to be stronger and the demand load tends to be lower, which should allow the batteries to be restored to full power before the demand load increases the next morning. The recharging of the batteries will be performed individually, such as one battery per battery charging generator or collectively. If the bank is charged collectively the power from each battery charging generator will be distributed evenly over the entire bank of batteries or over a subset of the entire bank of batteries.

Further, the plant management software program will automatically manage the amount of power generated and where it is directed at all times. If the PMSP software anticipates that the battery bank may not be adequately recharged (collectively or individually) by the five methods previously mentioned, it will schedule fully charged batteries to be brought to the power plant to replace or supplement the depleted batteries (see the battery sharing section below). The replacement or supplemented batteries will have been charged at another air era power plant location using 100% clean energy. With the ability to bring in charged batteries from other locations there will never be an interruption in power at any power plant, regardless of the amount of wind or sun available at the location. All power plants will always distribute 100% clean emission free power without interruption. In addition to powering the power production generators, the battery storage bank will provide a small amount of power to the turbine motors, which are part of the turbine velocity control system. Also, some of the power from the battery storage bank will be used to provide power to the building itself for lighting, electrical outlets, and equipment.

Some wind-based power plants may reside in areas where the wind is not constant all of the time or has certain months with long periods of dead calm. These power plants may not have enough available wind to keep up with the demand load and maintain an adequate charge of their battery power storage system bank. Therefore, the power plants are designed with the capability of transporting charged batteries to any location to ensure there is never an interruption of power in any power plant. The batteries that are slated to be available to other power plants may be stored at a location within the plant that makes them easy to charge and makes them easily accessible for pickup and delivery. There may be a constant rotation of delivering charged batteries to the other plants and bringing back depleted batteries to be charged to plants with excess power (“battery swapping”).

Potentially, there will be power plant charging depots located in high wind areas that are primarily dedicated to charging batteries. Anytime a plant anywhere in the world or in the depot's region requires charged batteries they will be shipped from the depot to the plant. The depleted batteries will be brought back to the depot to be charged and redistributed. The batteries will almost always be transported with electric vehicles or non-emission producing transportation. In some cases, it may be necessary to transport the charged batteries via aircraft or a ship that is not an emission free mode of transportation. Every effort will be made to reduce or eliminate these situations to keep the entire process emission free. However, even in the rare cases where emission producing transportation must be used the amount of non-emission power being created by the system will greatly offset the usage, compared to the electricity generating technologies that are currently being used throughout the world.

The full power plant tower will likely have a plurality of intermediate floors that could house “lion's den” battery power storage systems (BPSS). These intermediate floors would primarily be used for the battery storage units. Fully charged batteries may need to be swapped out for fully depleted or mostly depleted batteries if the BPSS cannot be adequately charged by the wind and or solar. The intermediate floors can also be used for miscellaneous storage of maintenance items and observation of the exterior of the building, as well as a platform to drop down for maintenance and cleaning of the exterior of the building.

Further, the power production generator assembly (PPGA) comprises a rotor velocity control system (RVCS), power production generator motors (PPGM), a fixed radial stanchion assembly (FRSA) that supports the power production generator motors (PPGM), fixed stator assembly (FSA), rotor carriage assemblies (RCA) (top & bottom, with associated roller systems) and a continuous rotor gear (CRG). The portion of the power production generator assembly that actually creates the electricity is comprised of two connected rotor carriage assemblies (RCA) and one fixed radial stator assembly (FRSA), which is typical for most electric generators. Further, there will be a bottom rotor assembly and an identical connected top rotor assembly that each supports a plurality of magnets. In between the rotor assemblies resides the fixed radial stator assembly (FRSA), which is comprised of a plurality of copper winding assemblies that remain stationary. The number of windings on the stator assembly matches the number and spacing of the magnets on the bottom rotor (the number of windings also match the number of magnets on the top rotor, which are the mates to the magnets on the bottom rotor). The rotor assemblies have carriage platforms that support the securely attached plurality of magnets. The magnets are arranged in opposing polarity pairs creating a magnetic field between them. The stator platform supports the copper windings and will be positioned in between the top and bottom rotor platforms so that the magnetic field passes through the copper windings when the rotors are put into motion by the power production generator motors. Each time a magnetic field passes through a copper winding an alternating flux is created in the magnetic copper windings and electricity is produced. In the case where the power generator is located on a turbine floor the outer portion of the radial generator assembly platform shall almost match the diameter of the inner portion of the wind turbine blades except there will be several feet of clearance for maintenance of the rotor. The inner portion of the generator assembly shall create enough space to house and support the carriage containing the plurality of magnets and copper windings that have been determined to be the optimal configuration to match the targeted electricity output and the size of the turbine blade assembly in each power plant. The electricity that is produced by the power production generator assembly is 3-phase, “alternating current” power or a/c power (as opposed to “direct current” power or d/c power). The magnets and copper windings are arranged to provide the proper frequency or hertz for the location that the power plant is operating in.

Further, an alternate generator design is called “reverse gear generators”. An alternate generator assembly configuration may be employed in the power plants called the reverse gear generator system. This generation system is different than the standard generator concept because the two platforms that support the plurality of magnets rotate in opposite directions. The two levels are paired by a reverse gear (or gears) that keeps the two generator magnet platform levels in precise registration at all times. The stator assemblies and their associated copper windings reside in between the two levels of horizontal generator rotor assembly platforms as they rotate in opposite directions. The reason the two generator assembly platforms will rotate in opposite directions is because of the way they are connected with the reverse gear(s). The bottom platform of the generators will be put into motion by the generator motor the same way the standard generator assembly is. A radial gear on the generator motor will mate with a continuous gear on the bottom platform of the generator. The principal difference between the standard generator configuration and the reverse gear generator system is that with the generators the alternating portion of the rotors are on an independent slave platform and they rotate in the opposite direction from the primary generator platform. With the rotor assemblies and associated magnets rotating in opposite directions they will pass the stators at a higher rpm and generate more power than the standard generator assembly design will.

An alternate generator configuration to the larger imaginary vertical axis generators may be a smaller footprint generator with fewer magnets on the rotor carriage and less matching copper windings. These smaller turbines may have a true vertical axis axel and spokes since egress through the center of the turbine is not necessary. The larger turbines encircle the entire nacelle of the building and must be larger to provide space for the stairs, elevators, and functionality. Multiple small footprint generators can reside inside the nacelle with egress around them. Even though the small generator's turbines will have fewer magnets and stators they can possibly create as much electricity as the large generators or more because there will be more generators and they will rotate at a much higher rpm. Potentially two, three, four, or more generators per turbine floor could be installed in a dedicated large power plant tower. The generators could even reside on any floor of the power plant as well as in another building that does not contain turbines. These generators would be powered by stored battery power like the “base design” generators. For this reason, they are not required to reside on the turbine floors. Charged batteries could be connected to or brought to where the generators reside. These generators could also reside in non-wind power plants as described below.

Further, the purpose of the plant management system (PMS) is to regulate the amount of power the power plant is producing at any one time, manage all moving components, and provide reporting and alerts. The actual plant management system (PMS) consists of seven primary components including the plant management software program, exterior conditions sensor system, wind vane assemblies, turbine velocity control system, battery charging generator controller (and/or off-the-shelf or proprietary generators that provide primary output power for sale), the braking & lockout assembly, rotor velocity control system and the power distribution management system.

The plant management software program manages the exterior conditions sensor system, wind vane assemblies, turbine velocity control system, the battery charging generators (and/or off-the-shelf or proprietary generators that provide primary output power for sale), the battery charging solar farm, the “lion's den” battery power storage system, and the braking & lockout assembly. All of these components take instructions from the plant management software program and work together to keep the power plant producing enough electricity to meet the demand load, without interruption. Error alerts for equipment that isn't working properly are sent back to the PMSP software to warn the operations team of potentially malfunctioning components. Error alerts for the battery backup system are managed by the software to ensure external measures are taken if the internal battery power storage system cannot keep up with the demand. Most, if not all of the functionality can be manually overridden.

The exterior conditions sensor system sends information such as wind speed, wind direction, barometric pressure, temperature, humidity, etc., to the plant management software program. There will be devices on the exterior of the building that take these readings and transmit them to the PMSP. The wind speed sensors will be installed in various locations on the outside of the building to read the wind speed and direction. There will also be wind speed sensors on the inside of the building at each turbine entry point to measure the speed of the wind after it enters the building. Using the target demand load and the information collected from the exterior conditions sensor system as a baseline the plant management software program will determine how far open or closed each wind vane assembly should be at any given time. Generally, the wind vanes will be kept open fully to allow as much wind as possible to enter the building. The only time the wind vanes will be partially closed is when the wind is so strong that it could damage the components of the power plant, or the battery power storage system is fully charged and the batteries don't need all of the turbines charging them at that time. The plant management software program can also be directed to close all of the wind vanes on one level to stop a single wind turbine assembly from rotating for maintenance and inspection. Finally, PMSP can close all of the wind vanes in the entire building to completely stop the battery power storage system from being charged. Another function of the exterior conditions sensor system will also work with the PMSP to determine which wind vanes should be open and which should be closed based on the direction of the wind. In the case of the alternate wind funnel intake ring, the PMSP rotates the intake ring's intake opening to match the direction of the wind.

The wind vane assemblies are managed by the plant management system in the following way. The plant management software program monitors the charge level of the battery power storage system and opens or closes the wind vanes as needed to regulate how many turbines are charging the battery power storage system at any given time. If the demand load is low and the batteries are not rapidly being depleted by the power production generator motors, then the software may close the wind vanes on several levels and lessen the rate the batteries are being charged (or in the case of the shroud it would rotate the intake opening away from the direction of the wind). The software may also partially close some of the wind vanes to keep them charging but at a lower rate. All aspects of the battery charging system are managed by the software and the wind vane assemblies are an integral component of the process. The turbine velocity control system uses motors to assist with the rotation of the turbines. It fully engages with the turbines during startup and provides intermittent boosts to the turbines to keep them rotating at the speed of the wind or higher. The PMSP will manage the startup of the turbines by opening the wind vanes, which will start the turbines in motion. At startup the TVCS will turn on the turbine motors and the clutch will engage the gears in the TVCS to assist with the ramping up of the rotation of the turbines to be equal or greater than the speed of the wind. Like a car transmission, the VCS will begin in low gear and increase to a higher gear once the turbine reaches optimum speed. The PMSP manages these components, which work together to attempt to keep the battery power storage system charged. The battery charging generator controller converts the inconsistent electricity' generated by the rotation of the turbines into the proper hertz or frequency so it can be used to charge the battery power storage system. The PMSP receives updates from the controllers to ensure the power the batteries are receiving is at the proper frequency and it monitors the charge level of the batteries. The controllers may be off-the-shelf products or may be proprietary controllers.

The braking and lockout system is controlled by the plant management software program for all automatic operations that require the turbines or the power production generators to be stopped when in rotation, and to be locked down when they are expected not to rotate. Users can press a button on the PMSP interface to apply the brake to halt any turbines/rotors in rotation that need to be stopped. Redundant safety measures are a part of the system to ensure that the wind turbine blades, or the rotors do not start when people are in the danger zone. The PMSP can also be manually overridden at each assembly and there will be a manual lockout pin that can be inserted to ensure the assemblies cannot start rotating inadvertently. The PMSP will sound warnings when the turbines or generators are about to be put into rotation and warning lights will indicate when turbines or rotors are and are not in physical lockdown mode. The PMSP will monitor and factor if any of the manual lockout pins are inserted.

The rotor velocity control system works in conjunction with the power production generator motors and the power distribution management system to rotate the rotor assemblies. The RVCS has a series of gears that shift as required to start the rotor assemblies in motion and to accelerate them and maintain them at the proper rpm's to meet the desired frequency (similar to a car's transmission). The plant management software program manages all aspects of the motors, RVCS, and rotor assemblies.

The power distribution management system is a software module within the plant management software program. It manages how much power the plant is selling to the grid and provides reporting and alerts regarding voltage, frequency, anticipated demand load, weather forecasting, etc. With this information, the system can determine if the plant is producing too much power and can shut down some of the turbines and/or shut down some of the generators. The PDMS can also predict if the battery power storage system is at risk of being depleted and schedule fully charged batteries to be brought in from other power plants in the network.

Some areas of the world will not have a high enough electricity demand load to justify the cost of constructing a full power plant. For these areas' smaller towers with less height and less diameter will be utilized. For example, a tower could be constructed that elevates the first wind turbine to approximately 40′ above grade level instead of approximately 90′ and only has 1-12 turbines instead of thirty-six or more. Potential sites for small power plants would be ones with a good average wind speed and an open area where the wind isn't blocked by trees or buildings. Another option would be to construct a small power plant on top of a hill that would naturally elevate the wind turbines high enough to encounter adequate wind speeds. The electrical generation technology for a small power plant would be the same as the dedicated large power plant, except that the components would be smaller and there would be less flux generated. With a smaller mass and footprint potentially the cost to build the plant would justify the amount of power that could be sold to the community.

A two-turbine embodiment of the small power plants has been developed that looks like and can operate as a lighthouse. This version of the power plant is appropriate for villages, islands, and coastal areas where smaller amounts of power are needed.

Other power plants that are smaller in size or that have fewer turbines may be constructed to power microgrids for university campuses, hospital complexes, amusement parks, military bases, industrial parks, large manufacturing plants, resorts, planned unit developments, etc.

Power plants may be owned by public or private utility companies that sell energy to customers on the open market. It is also possible for an end user who is constructing a high-rise building to incorporate one or several wind turbines into the design of their building or complex to create a microgrid. This type of customer may be a college campus, military base, medical center, etc. In all of these cases, the building owner could sell any excess power not used by their building or business to the local utility company. The generators powering these microgrids could be wind based or non-wind based.

These non-wind power plants utilize the same general technology as the large Berry Power Plants except there are no Wind Vanes and no Wind Turbines. With no wind turbines, it is not necessary for the power generating assemblies to be elevated.

Therefore, a plurality of Generator Assemblies can be located on any level of a building or in a basement. The generators may be stacked on top of each other to save space and allow for multiple generators in one building. These stand-alone generator assemblies are put into motion by the Rotor Motors that are powered by one battery per generator or by a “Lion's Den” Battery Power Storage System. The Power Plant Management Software Program would regulate the entire system and associated electricity production. The individual or stacked Generator Assemblies will be housed in a Berry non-wind-based Power Plant building, which could simply be a warehouse or typical low-rise office building. The excess power above the demand load will be used to recharge the batteries. Solar panels may be installed on the roof and/or covered parking solar panels may be constructed and used to provide additional recharging of the batteries. However, the batteries may need to be swapped out for fully charged batteries at certain intervals. This rotation of the batteries would be automatically scheduled by the Plant Management Software Program to ensure power is never interrupted. There may be some type of permeant storage built-into the system to allow the batteries to be swapped out without interrupting the power production. The generators for the non-wind power plants could be of any size. They could range from the size of the large Berry Power Plant to a generator that is small enough to power a house or small business.

Battery banks could reside in/on semi-truck beds/trailers and never be removed. The truck could pull into a dedicated parking spot at a Berry Power Plant. A pigtail would be plugged into a receptacle on the truck that is connected to the master power circuit. Then the PMSP Software would control the recharging of the batteries. When all the batteries in the battery bank were fully charged the truck would drive to another Berry Power Plant that needs charged batteries to operate. The truck would pull into a dedicated parking spot and plug in the pigtail on that building. Optimally, the trucks would be all electric semi-trucks, which would keep the process a clean, and zero emissions operation. If all electric semi-trucks are not available yet the batteries could reside on smaller trailers and currently available electrical vehicles could pull the trailers to where they need to be until the semi-trucks are available.

The battery banks could also be put in pods that are sized to be transported by an airplane. The company may own planes that can transport the batteries or they may be engineered to the precise size of a United Parcel Service™ or FedEx™ container to be shipped by a third-party carrier.

The same Air Era turbine and generator technology that is used for buildings can also be used to power ships. The voyage will start with the ship having fully charged batteries, which will power the motors to start the ship in motion. Once the ship reaches cruising speed the motion of the ship will create enough wind to rotate the wind turbines and charge the batteries. The charged batteries would power electric motors that put the propellers in motion. The disclosed system solves all the problems of the existing technology. The disclosed system is affordable, 100% renewable, and has zero emissions. The power plants disclosed in the present disclosure are projected to have the lowest levelized cost of electricity and the monthly charge to the consumer will be much lower.The disclosed system will save the world from destroying the beautiful views found in the United States and around the world. This power plant concept replaces the unattractive single turbine wind turbines with stacked wind turbines inside of beautiful buildings. The disclosed system relates generally to buildings, specifically buildings with an integrated system for generating electricity from wind. Further, the present disclosure describes a wind based power plant building.

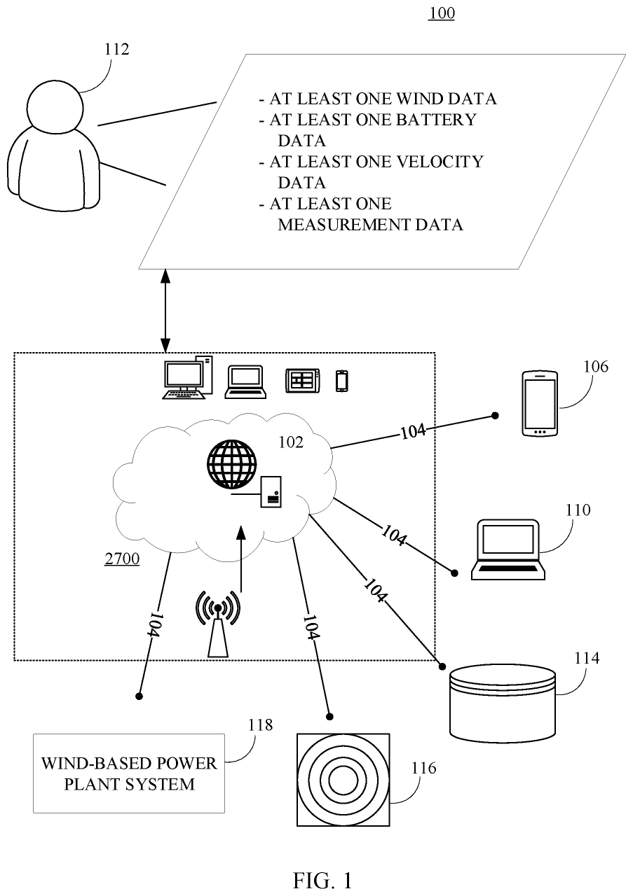

FIG. 1 is an illustration of an online platform 100 consistent with various embodiments of the present disclosure. By way of non-limiting example, the online platform 100 to facilitate providing an electrical power to an electrical load may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, and a wind-based power plant system 118 (such as a wind-based power plant system 200, a wind-based power plant system 1500, a wind-based power plant system 1900, etc.) over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2700.

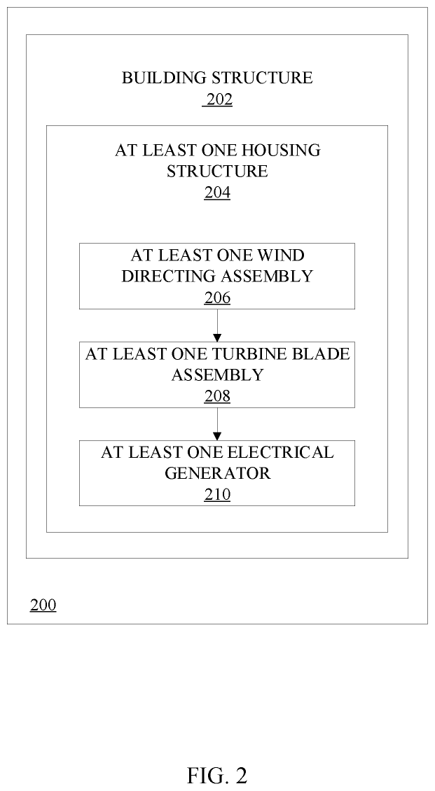

FIG. 2 is a block diagram of a wind-based power plant system 200 for providing an electrical power to an electrical load, in accordance with some embodiments. Accordingly, the wind-based power plant system 200 may include a building structure 202, at least one wind directing assembly 206, at least one turbine blade assembly 208, and at least one electrical generator 210. Further, the electrical load may include a microgrid, a local grid, a national grid, etc.

Further, the building structure 202 may be vertically erectable on a surface. Further, the building structure 202 may include at least one housing structure 204. Further, the at least one housing structure 204 may be vertically stacked for forming the building structure 202. Further, the at least one housing structure 204 corresponds to at least one floor of the buiding structure 202.

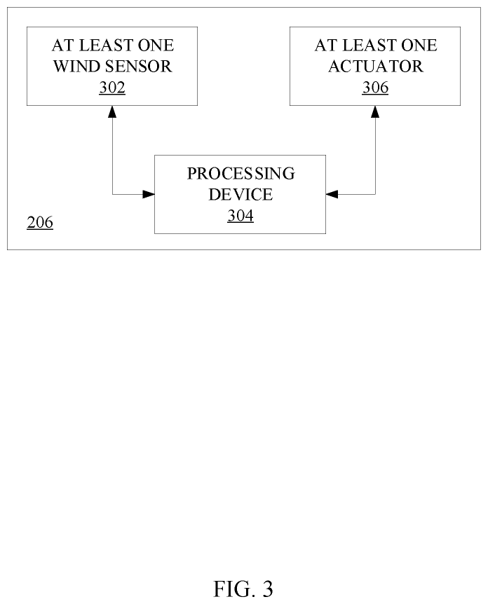

Further, the at least one wind directing assembly 206 may be disposed in the at least one housing structure 204. Further, a wind directing assembly of the at least one wind directing assembly 206 disposed in a housing structure of the at least one housing structure 204 may be configured for allowing entering of wind in the housing structure from a first side of the housing structure. Further, the wind directing assembly may be configured for allowing exiting of the wind from a second side of the housing structure. Further, the wind directing assembly may be configured for at least one of controlling and creating a flow of the wind based on at least one of the allowing entering of the wind and the allowing exiting of the wind. Further, the wind directing assembly may be transitionable between a plurality of wind directing states of the wind directing assembly for the at least one of the allowing entering of the wind and the allowing exiting of the wind. Further, the wind directing assembly may include at least one wind sensor 302, as shown in FIG. 3, a processing device 304, as shown in FIG. 3, and at least one actuator 306, as shown in FIG. 3. Further, the at least one wind sensor 302 may be disposed in the housing structure. Further, the at least one wind sensor 302 may be configured for generating at least one wind data based on at least one of a direction of the wind and a velocity of the wind associated with the housing structure. Further, the direction of the wind may be a wind azimuth. Further, the processing device 304 may be communicatively coupled with the at least one wind sensor 302. Further, the processing device 304 may be configured for analyzing the at least one wind data. Further, the processing device 304 may be configured for generating a command based on the analyzing. Further, the at least one actuator 306 may be disposed in the housing structure. Further, the at least one actuator 306 may be operationally coupled with the wind directing assembly. Further, the at least one actuator 306 may be communicatively coupled with the processing device 304. Further, the at least one actuator 306 may be configured for transitioning the wind directing assembly between the plurality of wind directing states of the wind directing assembly based on the command.

Further, at least one turbine blade assembly 208 may be disposed in the at least one housing structure 204. Further, a turbine blade assembly of the at least one turbine blade assembly 208 disposed in the housing structure may include a plurality of wind turbine blades arranged radially around a vertical axis of the building structure 202 in the housing structure. Further, the plurality of wind turbine blades may be configured for intercepting the flow of the wind. Further, the plurality of wind turbine blades may be configured for rotating around the vertical axis based on the intercepting.

Further, the at least one electrical generator 210 may be disposed in the at least one housing structure 204. Further, the at least one electrical generator 210 may be mechanically coupled with the at least one turbine blade assembly 208. Further, an electrical generator of the at least one electrical generator 210 disposed in the housing structure may be configured for generating the electrical power based on the rotating. Further, the at least one electrical generator 210 may be electrically couplable to the electrical load for providing the electrical power to the electrical load.

In further embodiments, a communication device may be communicatively coupled with the at least one wind sensor 302. Further, the communication device may be configured for transmitting the at least one wind data to at least one user device. Further, the at least one user device may include a computing device such as, but not limited to, a smartphone, a smartwatch, a tablet, a laptop, a desktop, etc. Further, the at least one user device may be associated with at least one user. Further, the at least one user may include an individual, an institution, an organization, etc.

In further embodiments, a storage device may be communicatively coupled with the at least one wind sensor 302. Further, the storage device may be configured for storing the at least one wind data.

Further, in some embodiments, the wind directing assembly may include a wind vane assembly. Further, the wind vane assembly may include a plurality of wind vanes. Further, the plurality of wind vanes may be peripherally disposed around a housing structure periphery of the housing structure. Further, the plurality of wind directing states corresponds to a plurality of vane positions of a wind vane of the plurality of wind vanes about at least one of a horizontal vane axis of the wind vane and a vertical vane axis of the wind vane. Further, the plurality of wind vanes may be transitionable between the plurality of vane positions forming a first openably closable opening on the first side and a second opneably closable opening on the second side for the allowing entering of the wind and the allowing exiting of the wind.

Further, in some embodiments, the wind directing assembly may include a wind funnel intake ring. Further, the wind funnel intake ring may be peripherally disposed around a housing structure periphery of the housing structure. Further, the wind funnel intake ring may include a funnel portion and a tail portion. Further, the funnel portion may include a funnel opening corresponding to the first side and the tail portion may include a tail opening corresponding to the second side. Further, the funnel portion increases the velocity of the wind entering the funnel opening and exiting the tail opening based on a wind tunnel effect. Further, the plurality of wind directing states corresponds to a plurality of funnel intake ring positions about the vertical axis. Further, the wind funnel intake ring may be rotatable around the vertical axis for transitioning between the plurality of funnel intake ring positions. Further, in an embodiment, the wind funnel intake ring may include a slidable door disposed in the funnel portion of the wind funnel intake ring. Further, the slidable door may be slidable between a plurality of sliding positions for opneably closing the funnel opening. Further, the plurality of wind directing states corresponds to the plurality of sliding positions.

Further, in some embodiments, the turbine blade assembly may include a plurality of support rails disposed in the housing structure. Further, the plurality of support rails may be concentric and radially spaced. Further, the plurality of support rails may be configured for supporting the plurality of wind turbine blades. Further, the plurality of support rails forms a plurality of tracks. Further, the plurality of wind turbine blades contactably moves on the plurality of tracks based on the rotating.

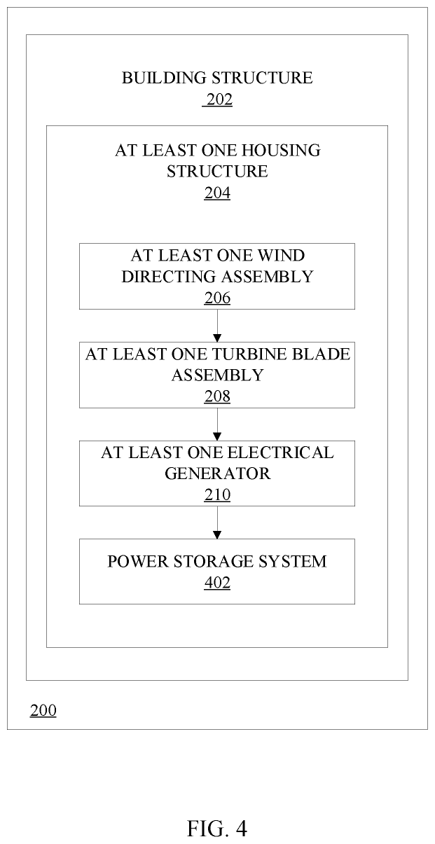

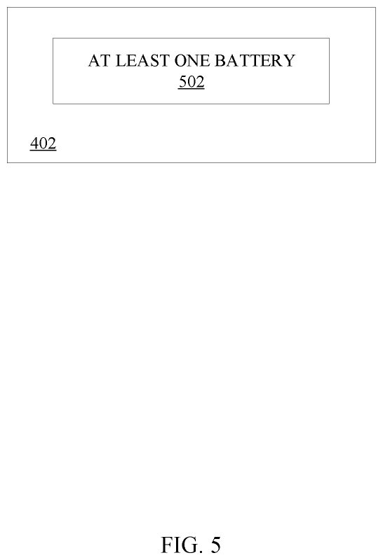

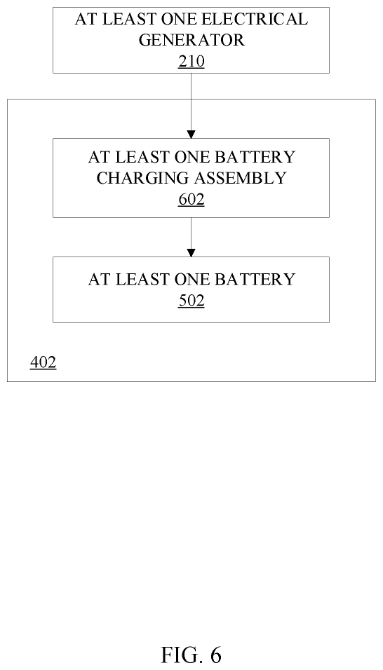

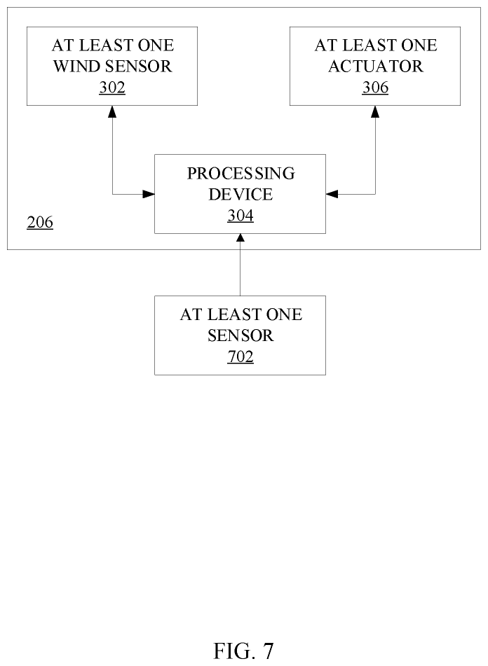

In further embodiments, a power storage system 402, as shown in FIG. 4, may be electrically coupled with the at least one electrical generator 210. Further, the power storage system 402 may include at least one battery 502, as shown in FIG. 5. Further, the at least one battery 502 forms at least one battery bank. Further, the at least one battery 502 may be configured for receiving the electrical power from the at least one electrical generator 210. Further, the at least one battery 502 stores the electrical power based on the receiving. Further, the electrical power may include a DC electrical power. Further, the DC power may be associated with a DC voltage level, a DC current level, etc. Further, the power storage system 402 may be electrically couplable to the electrical load for providing the electrical power to the electrical load. Further, in an embodiment, the power storage system 402 may include at least one battery charging assembly 602, as shown in FIG. 6. Further, the at least one battery 502 may be removably disposed in the at least one housing structure 204. Further, the at least one battery charging assembly 602 may be configured for detachably connecting the at least one battery 502 to the at least one electrical generator 210. Further, the at least one battery charging assembly 602 transitions between a connected state and a disconnected state based on the detachably connecting. Further, the at least one battery 502 receives the electrical power in the connected state. Further, the at least one battery 502 does not receive the electrical power in the disconnected state. In further embodiments, at least one sensor 702, as shown in FIG. 7, may be disposed in the housing structure. Further, the at least one sensor 702 may be communicatively coupled with the processing device 304. Further, the at least one sensor 702 may be configured for generating at least one battery data based on a charge level of the at least one battery 502. Further, the charge level indicates an amount of charge left in the at least one battery 502. Further, the processing device 304 may be configured for analyzing the at least one battery data based on a predetermined range of the charge level. Further, the processing device 304 may be configured for generating a sixth command based on the analyzing of the at least one battery data. Further, the at least one actuator 306 may be configured for transitioning the wind directing assembly between the plurality of wind directing states of the wind directing assembly based on the sixth command. In further embodiments, a communication device may be communicatively coupled with the at least one sensor 702. Further, the communication device may be configured for transmitting the at least one battery data to the at least one user device.

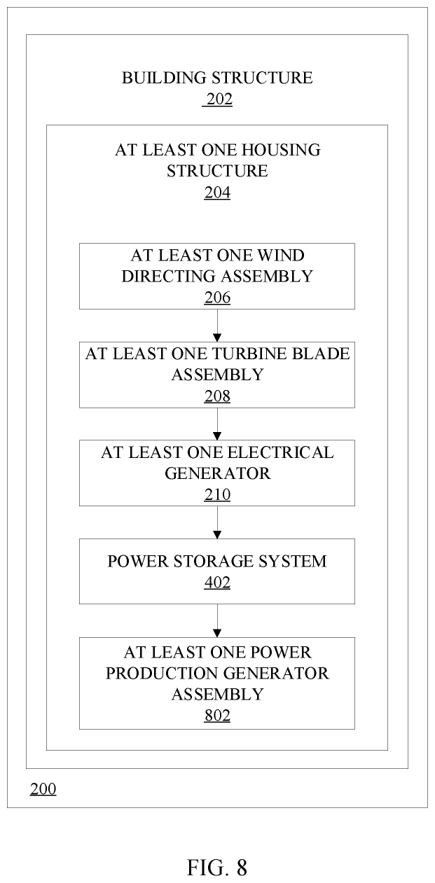

In further embodiments, at least one power production generator assembly 802, as shown in FIG. 8, may be disposed in the at least one housing structure 204. Further, a power production generator assembly of the at least one power production generator assembly 802 disposed in the housing structure may include two rotor assemblies, a stator assembly, and at least one power production generator motor. Further, the two rotor assemblies may include a top rotor assembly and a bottom rotor assembly. Further, the top rotor assembly may include a top rotor platform and a plurality of top rotor magnets disposed on a first surface of the top rotor platform. Further, the plurality of top rotor magnets may be arranged in an alternating polarity of the plurality of top rotor magnets. Further, the plurality of top rotor magnets may be a plurality of permanent magnets. Further, the bottom rotor assembly may include a bottom rotor platform and a plurality of bottom rotor magnets disposed on a second surface of the bottom rotor platform. Further, the plurality of bottom rotor magnets may be arranged in an alternating polarity of the plurality of bottom rotor magnets. Further, the plurality of bottom rotor magnets may be a plurality of permanent magnets. Further, the second surface opposes the first surface. Further, the stator assembly may be disposed between the two rotor assemblies. Further, the stator assembly may be adjacent to each of the first surface and the second surface. Further, the stator assembly may include a stator platform and a plurality of windings disposed on the stator platform. Further, the plurality of windings corresponds to the plurality of top rotor magnets and the plurality of bottom rotor magnets. Further, the at least one power production generator motor may be electrically coupled with the power storage system 402. Further, the at least one power production generator motor may be mechanically coupled with the two rotor assemblies. Further, the at least one power production generator motor may be configured for receiving the electrical power from the at least one battery 502. Further, the at least one power production generator motor may be configured for rotating the two rotor assemblies in relation to the stator assembly around the vertical axis based on the receiving of the electrical power. Further, the at least one power production generator assembly 802 may be configured for generating the electrical power based on the rotating of the two rotor assemblies. Further, the electrical power may be an AC electrical power. Further, the AC power may be associated with an AC voltage level, an AC current level, a number of phase, a frequency, etc. Further, the at least one power production generator assembly 802 may be electrically couplable to the electrical load for providing the electrical power to the electrical load. Further, in an embodiment, the at least one power production generator motor may be configured for rotating the top rotor assembly and the bottom rotor assembly in relation to the stator assembly around the vertical axis in opposite directions. Further, a first direction of the rotating of the top rotor assembly may be opposite to a second direction of the rotating of the bottom rotor assembly. Further, in an embodiment, the at least one power production generator motor may be configured for rotating the top rotor assembly and the bottom rotor assembly in relation to the stator assembly around the vertical axis in similar directions. Further, a first direction of the rotating of the top rotor assembly may be similar to a second direction of the rotating of the bottom rotor assembly.

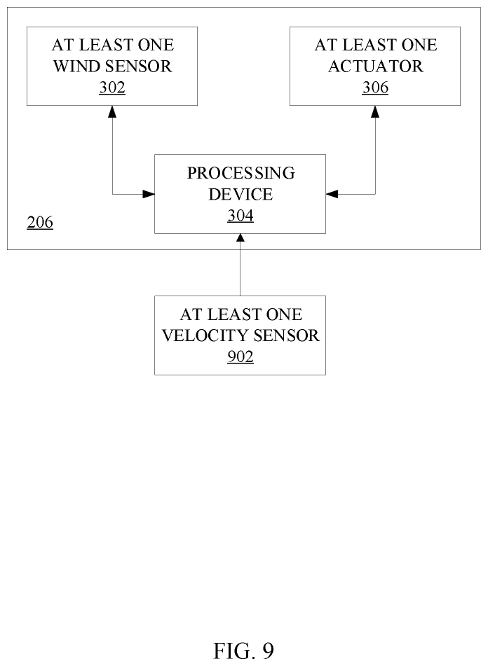

In further embodiments, at least one velocity sensor 902, as shown in FIG. 9, may be disposed on the turbine blade assembly. Further, the at least one velocity sensor 902 may be communicatively coupled with the processing device 304. Further, the at least one velocity sensor 902 may be configured for generating at least one velocity data based on a velocity of the plurality of wind turbine blades. Further, the processing device 304 may be configured for analyzing the at least one velocity data based on a predetermined range of the velocity of the plurality of wind turbine blades. Further, the processing device 304 may be configured for generating a first command based on the analyzing of the at least one velocity data. Further, the at least one actuator 306 may be configured for transitioning the wind directing assembly between the plurality of wind directing states based on the first command. In further embodiments, a communication device may be communicatively coupled with the at least one velocity sensor 902. Further, the communication device may be configured for transmitting the at least one velocity data to the at least one user device.

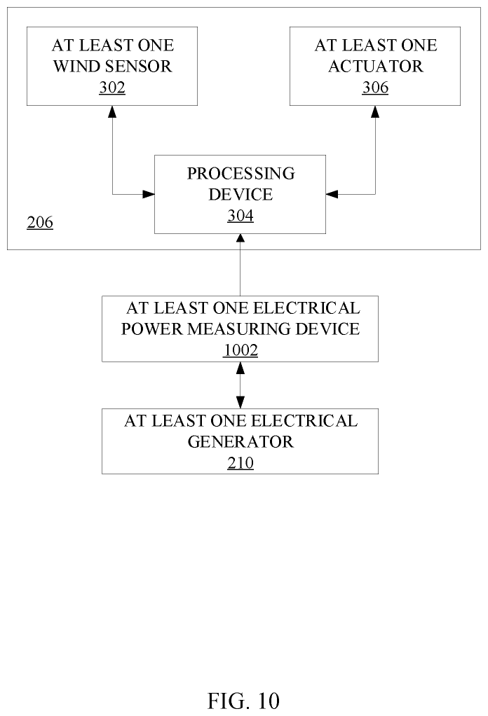

In further embodiments, at least one electrical power measuring device 1002, as shown in FIG. 10, may be electrically coupled with the electrical generator. Further, the at least one electrical power measuring device 1002 may be communicatively coupled with the processing device 304. Further, the at least one electrical power measuring device 1002 may be configured for generating at least one measurement data based on measuring at least one value of at least one electrical parameter of the electrical power. Further, the at least one electrical parameter may include a voltage, a current, an active power, a reactive power, an apparent power, a frequency, etc. Further, the processing device 304 may be configured for analyzing the at least one measurement data based on a predetermined range of the at least one value of the at least one electrical parameter of the electrical power. Further, the processing device 304 may be configured for generating a second command based on the analyzing of the at least one measurement data. Further, the at least one actuator 306 may be configured for transitioning the wind directing assembly between the plurality of wind directing states of the wind directing assembly based on the second command. In further embodiments, a communication device may be communicatively coupled with the at least one electrical power measuring device 1002. Further, the communication device may be configured for transmitting the at least one measurement data to the at least one user device.

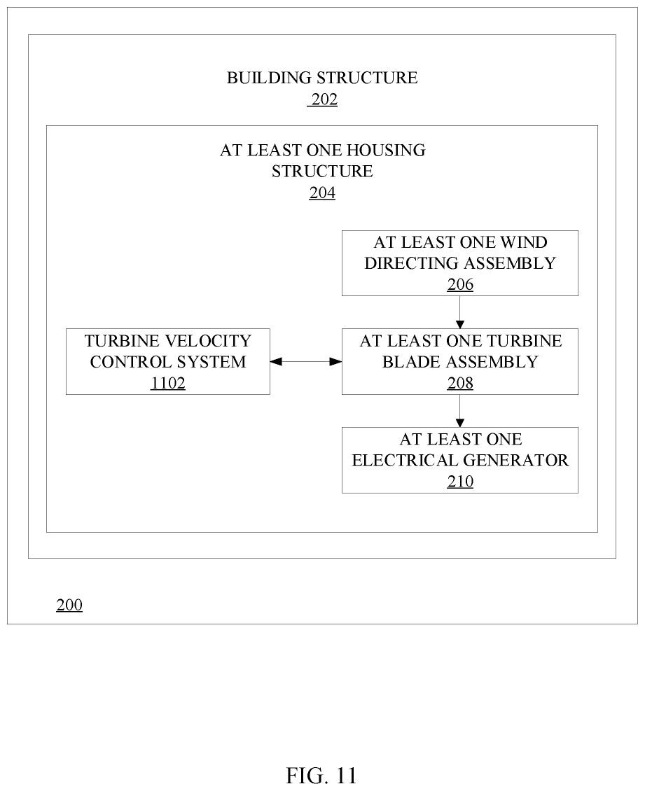

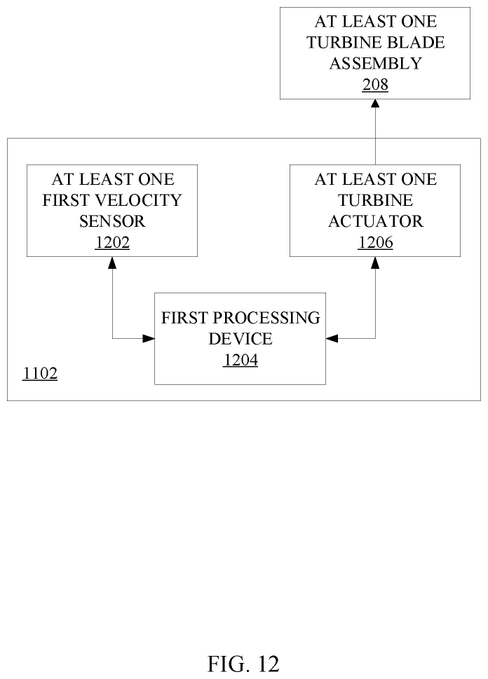

In further embodiments, a turbine velocity control system 1102, as shown in FIG. 11, may be disposed in the at least one housing structure 204. Further, the turbine velocity control system 1102 may be coupled with the at least one turbine blade assembly 208. Further, the turbine velocity control system 1102 may include at least one first velocity sensor 1202, as shown in FIG. 12, a first processing device 1204, as shown in FIG. 12, and at least one turbine actuator 1206, as shown in FIG. 12. Further, the at least one first velocity sensor 1202 may be configured for generating at least one first velocity data based on a velocity of the plurality of wind turbine blades. Further, the first processing device 1204 may be communicatively coupled with the at least one first velocity sensor 1202. Further, the first processing device 1204 may be configured for analyzing the at least one first velocity data based on a predetermined range of the velocity of the plurality of wind turbine blades. Further, the first processing device 1204 may be configured for analyzing generating a third command based on the analyzing of the at least one first velocity data. Further, the at least one turbine actuator 1206 communicatively coupled with the first processing device 1204. Further, the at least one turbine actuator 1206 may be operationally coupled with the at least one turbine blade assembly 208. Further, the at least one turbine actuator 1206 may be configured for modifying the velocity of the plurality of wind turbine blades based on the third command. Further, the at least one turbine actuator 1206 may include at least one turbine motor. Further, the at least one turbine motor may be at least one servo motor.

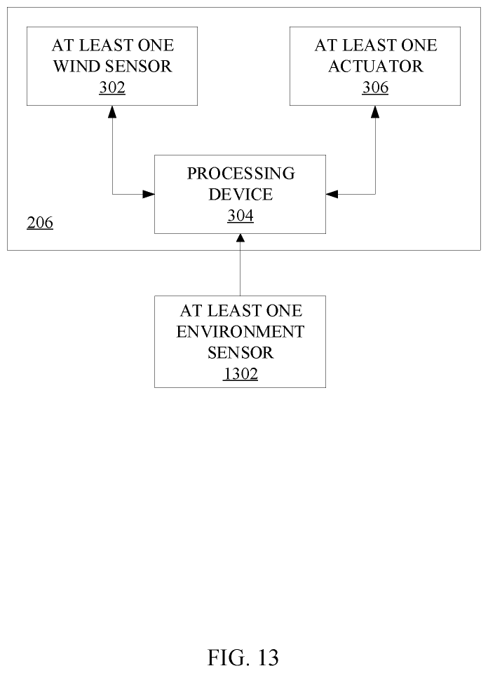

In further embodiments, at least one environment sensor 1302, as shown in FIG. 13, may be disposed in the housing structure. Further, the at least one environment sensor 1302 may be communicatively coupled with the processing device 304. Further, the at least one environment sensor 1302 may be configured for generating at least one environment data based on an environment of the building structure 202. Further, the processing device 304 may be configured for analyzing the at least one environment data. Further, the processing device 304 may be configured for analyzing determining at least one environmental condition of the environment based on the analyzing of the at least one environment data. Further, the at least one environmental condition may include a temperature, a pressure, a humidity, a solar insolation, a precipitation, etc. Further, the processing device 304 may be configured for analyzing generating a fourth command based on the determining. Further, the at least one actuator 306 may be configured for transitioning the wind directing assembly between the plurality of wind directing states of the wind directing assembly based on the fourth command. Further, the at least one actuator 306 may include at least one electric powered motor. Further, the at least one electric powered motor may be at least one servo motor.

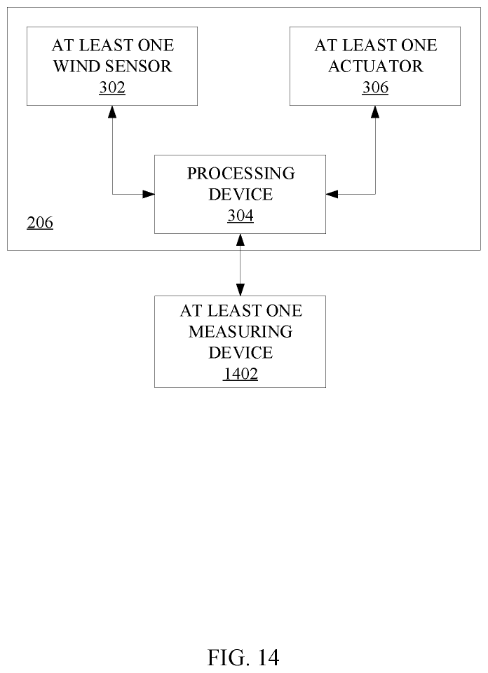

In further embodiments, at least one measuring device 1402, as shown in FIG. 14, may be electrically couplable to the electrical load. Further, the at least one measuring device 1402 may be communicatively coupled with the processing device 304. Further, the at least one measuring device 1402 may be configured for measuring an electrical power demand associated with the electrical load. Further, the at least one measuring device 1402 may be configured for generating at least one electrical power demand data based on the measuring. Further, the processing device 304 may be configured for analyzing the at least one electrical power demand data. Further, the processing device 304 may be configured for generating a fifth command based on the analyzing of the at least one electrical power demand data. Further, the at least one actuator 306 may be configured for transitioning the wind directing assembly between the plurality of wind directing states of the wind directing assembly based on the fifth command.

FIG. 3 is a block diagram of the at least one wind directing assembly 206 of the wind-based power plant system 200, in accordance with some embodiments.

FIG. 4 is a block diagram of the wind-based power plant system 200 with the power storage system 402, in accordance with some embodiments.

FIG. 5 is a block diagram of the power storage system 402 of the wind-based power plant system 200, in accordance with some embodiments.

FIG. 6 is a block diagram of the power storage system 402 with the at least one battery charging assembly 602, in accordance with some embodiments.

FIG. 7 is a block diagram of the at least one wind directing assembly 206 with the at least one sensor 702, in accordance with some embodiments.

FIG. 8 is a block diagram of the wind-based power plant system 200 with the power storage system 402 and the at least one power production generator assembly 802, in accordance with some embodiments.

FIG. 9 is a block diagram of the at least one wind directing assembly 206 with the at least one velocity sensor 902, in accordance with some embodiments.

FIG. 10 is a block diagram of the at least one wind directing assembly 206 with the at least one electrical power measuring device 1002, in accordance with some embodiments.

FIG. 11 is a block diagram of the wind-based power plant system 200 with the turbine velocity control system 1102, in accordance with some embodiments.

FIG. 12 is a block diagram of the turbine velocity control system 1102 of the wind-based power plant system 200, in accordance with some embodiments.

FIG. 13 is a block diagram of the at least one wind directing assembly 206 with the at least one environment sensor 1302, in accordance with some embodiments.

FIG. 14 is a block diagram of the at least one wind directing assembly 206 with the at least one measuring device 1402, in accordance with some embodiments.

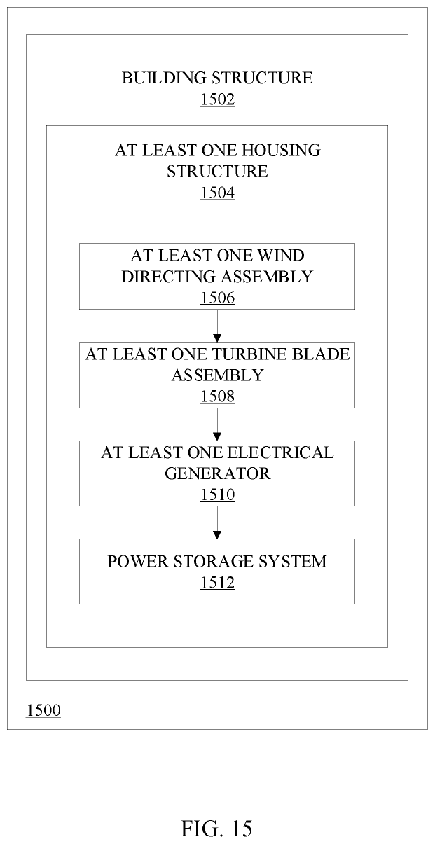

FIG. 15 is a block diagram of a wind-based power plant system 1500 for providing an electrical power to an electrical load, in accordance with some embodiments. Accordingly, the wind-based power plant system 1500 may include a building structure 1502, at least one wind directing assembly 1506, at least one turbine blade assembly 1508, at least one electrical generator 1510, and a power storage system 1512.

Further, the building structure 1502 may be vertically erectable on a surface. Further, the building structure 1502 may include at least one housing structure 1504. Further, the at least one housing structure 1504 may be vertically stacked forming the building structure 1502.

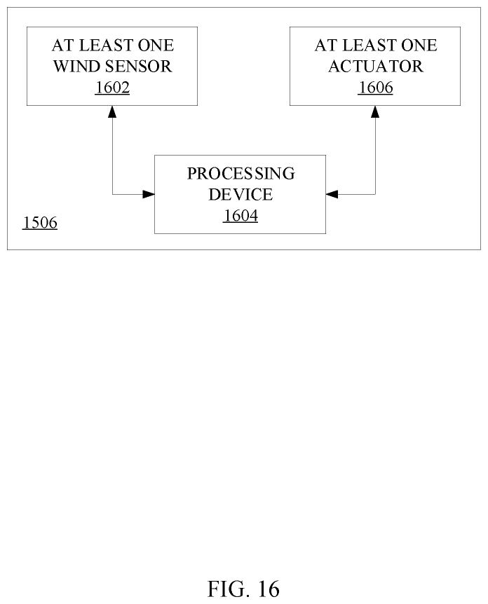

Further, the at least one wind directing assembly 1506 may be disposed in the at least one housing structure 1504. Further, a wind directing assembly of the at least one wind directing assembly 1506 disposed in a housing structure of the at least one housing structure 1504 may be configured for allowing entering of wind in the housing structure from a first side of the housing structure. Further, the wind directing assembly may be configured for allowing exiting of the wind from a second side of the housing structure. Further, the wind directing assembly may be configured for at least one of controlling and creating a flow of the wind based on at least one of the allowing entering of the wind and the allowing exiting of the wind. Further, the wind directing assembly may be transitionable between a plurality of wind directing states of the wind directing assembly for the at least one of the allowing entering of the wind and the allowing exiting of the wind. Further, the wind directing assembly may include at least one wind sensor 1602, as shown in FIG. 16, a processing device 1604, as shown in FIG. 16, and at least one actuator 1606, as shown in FIG. 16. Further, the at least one wind sensor 1602 may be disposed in the housing structure. Further, the at least one wind sensor 1602 may be configured for generating at least one wind data based on at least one of a direction of the wind and a velocity of the wind associated with the housing structure. Further, the processing device 1604 may be communicatively coupled with the at least one wind sensor 1602. Further, the processing device 1604 may be configured for analyzing the at least one wind data. Further, the processing device 1604 may be configured for generating a command based on the analyzing. Further, the at least one actuator 1606 may be disposed in the housing structure. Further, the at least one actuator 1606 may be operationally coupled with the wind directing assembly. Further, the at least one actuator 1606 may be communicatively coupled with the processing device 1604. Further, the at least one actuator 1606 may be configured for transitioning the wind directing assembly between the plurality of wind directing states of the wind directing assembly based on the command.

Further, the at least one turbine blade assembly 1508 may be disposed in the at least one housing structure 1504. Further, a turbine blade assembly of the at least one turbine blade assembly 1508 disposed in the housing structure may include a plurality of wind turbine blades arranged radially around a vertical axis of the building structure 1502 in the housing structure. Further, the plurality of wind turbine blades may be configured for intercepting the flow of the wind. Further, the plurality of wind turbine blades may be configured for rotating around the vertical axis based on the intercepting.

Further, the at least one electrical generator 1510 may be disposed in the at least one housing structure 1504. Further, the at least one electrical generator 1510 may be mechanically coupled with the at least one turbine blade assembly 1508. Further, an electrical generator of the at least one electrical generator 1510 disposed in the housing structure may be configured for generating the electrical power based on the rotating. Further, the at least one electrical generator 1510 may be electrically couplable to the electrical load for providing the electrical power to the electrical load.

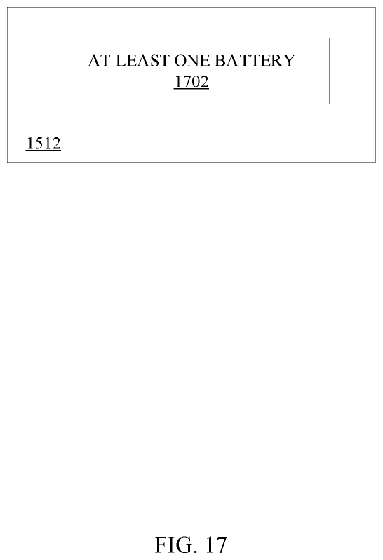

Further, the power storage system 1512 may be electrically coupled with the at least one electrical generator 1510. Further, the power storage system 1512 may include at least one battery 1702, as shown in FIG. 17. Further, the at least one battery 1702 may be configured for receiving the electrical power from the at least one electrical generator 1510. Further, the at least one battery 1702 stores the electrical power based on the receiving. Further, the electrical power may include a DC electrical power. Further, the power storage system 1512 may be electrically couplable to the electrical load for providing the electrical power to the electrical load.

Further, in some embodiments, the wind directing assembly may include a wind vane assembly. Further, the wind vane assembly may include a plurality of wind vanes. Further, the plurality of wind vanes may be peripherally disposed around a housing structure periphery of the housing structure. Further, the plurality of wind directing states corresponds to a plurality of vane positions of a wind vane of the plurality of wind vanes about at least one of a horizontal vane axis of the wind vane and a vertical vane axis of the wind vane. Further, the plurality of wind vanes may be transitionable between the plurality of vane positions forming a first openably closable opening on the first side and a second opneably closable opening on the second side for the allowing entering of the wind and the allowing exiting of the wind.

Further, in some embodiments, the wind directing assembly may include a wind funnel intake ring. Further, the wind funnel intake ring may be peripherally disposed around a housing structure periphery of the housing structure. Further, the wind funnel intake ring may include a funnel portion and a tail portion. Further, the funnel portion may include a funnel opening corresponding to the first side and the tail portion may include a tail opening corresponding to the second side. Further, the funnel portion increases the velocity of the wind entering the funnel opening and exiting the tail opening based on a wind tunnel effect. Further, the plurality of wind directing states corresponds to a plurality of funnel intake ring positions about the vertical axis. Further, the wind funnel intake ring may be rotatable around the vertical axis for transitioning between the plurality of funnel intake ring positions.

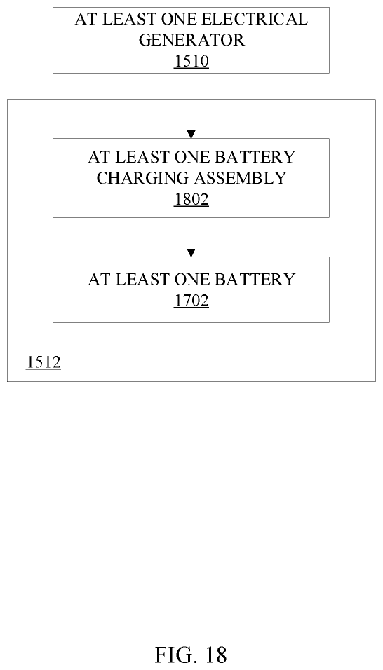

Further, in some embodiments, the power storage system 1512 may include at least one battery charging assembly 1802, as shown in FIG. 18. Further, the at least one battery 1702 may be removably disposed in the at least one housing structure 1504. Further, the at least one battery charging assembly 1802 may be configured for detachably connecting the at least one battery 1702 to the at least one electrical generator 1510. Further, the at least one battery charging assembly 1802 transitions between a connected state and a disconnected state based on the detachably connecting. Further, the at least one battery 1702 receives the electrical power in the connected state. Further, the at least one battery 1702 does not receive the electrical power in the disconnected state.

FIG. 16 is a block diagram of the at least one wind directing assembly 1506 of the wind-based power plant system 1500, in accordance with some embodiments.

FIG. 17 is a block diagram of the power storage system 1512 of the wind-based power plant system 1500, in accordance with some embodiments.

FIG. 18 is a block diagram of the power storage system 1512 with the at least one battery charging assembly 1802, in accordance with some embodiments.

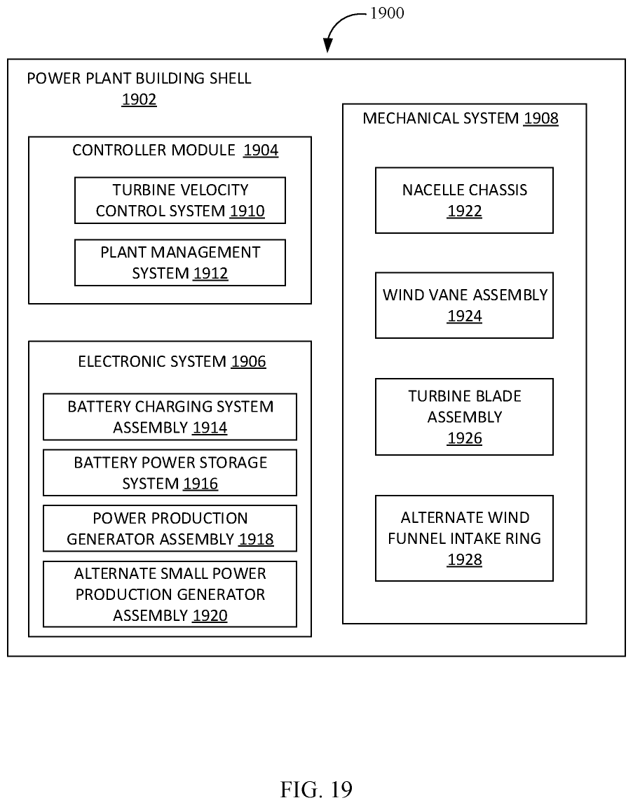

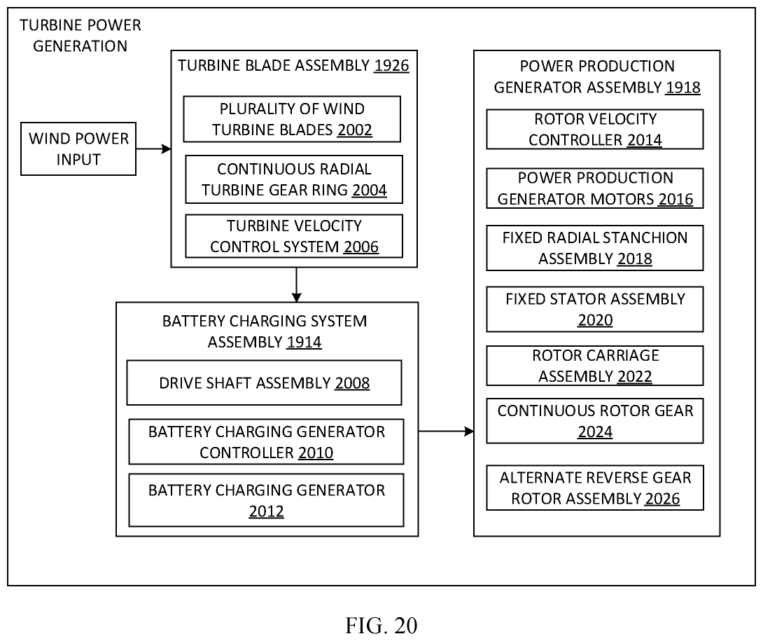

FIG. 19 is a block diagram of a wind-based power plant system 1900 for providing an electrical power to an electrical load, in accordance with some embodiments. Further, the wind-based power plant system 1900 may include a power plant building shell 1902. Further, the power plant building shell 1902 may include a controller module 1904, an electronic system 1906, and a mechanical system 1908.

Further, the controller module 1904 may include a turbine velocity control system 1910 and a plant management system 1912.

Further, the electronic system 1906 may include a battery charging system assembly 1914, a battery power storage system 1916, a power production generator assembly 1918, and an alternate small power production generator assembly 1920.

Further, the mechanical system may include a nacelle chassis 1922, a wind vane assembly 1924, a turbine blade assembly 1926, and an alternate wind funnel intake ring 1928.

FIG. 20 is a block diagram of the turbine blade assembly 1926, the battery charging system assembly 1914, and the power production generator assembly 1918 for generating the electrical power, in accordance with some embodiments.

Further, the turbine blade assembly 1926 receives a wind power input. Further, the turbine blade assembly 1926 may include a plurality of wind turbine blades 2002, a continuous radial turbine gear ring 2004, and a turbine velocity control system 2006.

Further, the battery charging system assembly 1914 may include a drive shaft assembly 2008, a battery charging generator controller 2010, and a battery charging generator 2012.

Further, the power production generator assembly 1918 may include a rotor velocity controller 2014, power production generator motors 2016, a fixed radial stanchion assembly 2018, a fixed stator assembly 2020, a rotor carriage assembly 2022, a continuous rotor gear 2024, and an alternate reverse gear rotor assembly 2026.

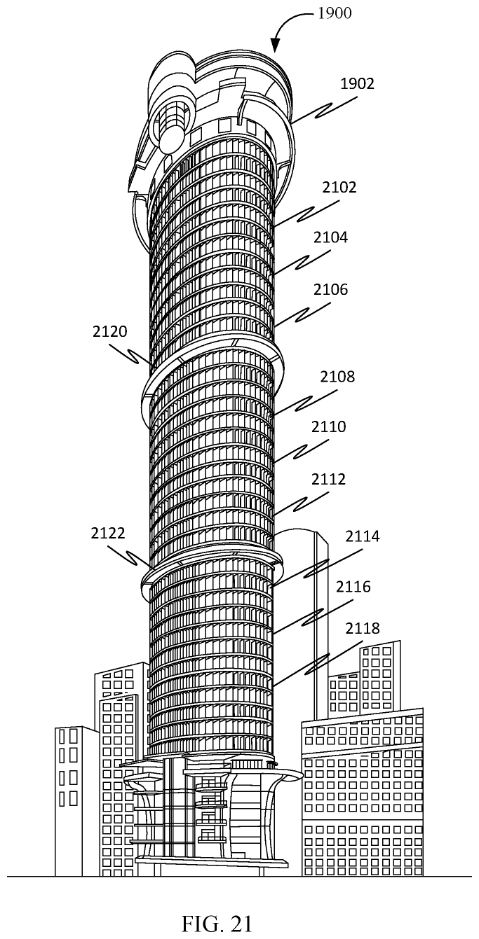

FIG. 21 is a front view of the wind-based power plant system 1900 for providing the electrical power to the electrical load, in accordance with some embodiments. Further, the wind-based power plant system 1900 may include the power plant building shell 1902. Further, the power plant building shell 1902 may include at least one turbine level 2102-2118. Further, the at least one turbine level 2102-2118 may be at least one housing structure of the power plant building shell (such as the at least one housing structure 202). Further, the power plant building shell 1902 may include at least one intermediate floor 2120-2122 stacked between the at least one turbine level 2102-2118.

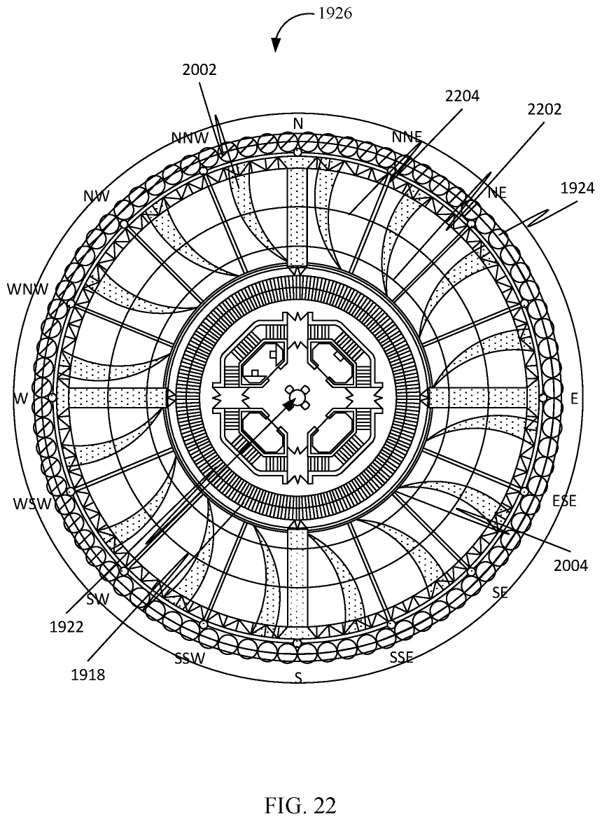

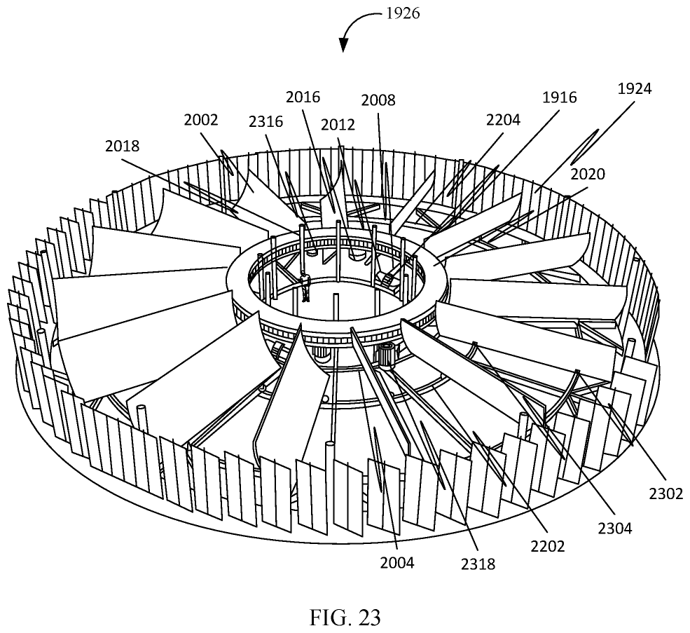

FIG. 22 is a top view of the turbine blade assembly 1926 of the wind-based power plant system 1900, in accordance with some embodiments. Further, the turbine blade assembly 1926 may be disposed in the at least one turbine level 2102-2118. Further, the turbine blade assembly 1926 may include the wind vane assembly 1924, a turbine blade support system 2202-2204, the plurality of wind turbine blades 2002, and the continuous radial turbine gear ring 2004. Further, the at least one turbine level 2102-2118 may include the nacelle chassis 1922. Further, the at least one turbine level 2102-2118 may include the power production generator assembly 1918. Further, the plurality of wind turbine blades 2002 may include a plurality of trucks 2302-2304, as shown in FIG. 23. Further, the turbine velocity control system 1910 disposed of in the at least one turbine level 2102-2118 may include one or more turbine motors 2316-2318, as shown in FIG. 23.

FIG. 23 is a perspective view of the turbine blade assembly 1926 of the wind-based power plant system 1900, in accordance with some embodiments.

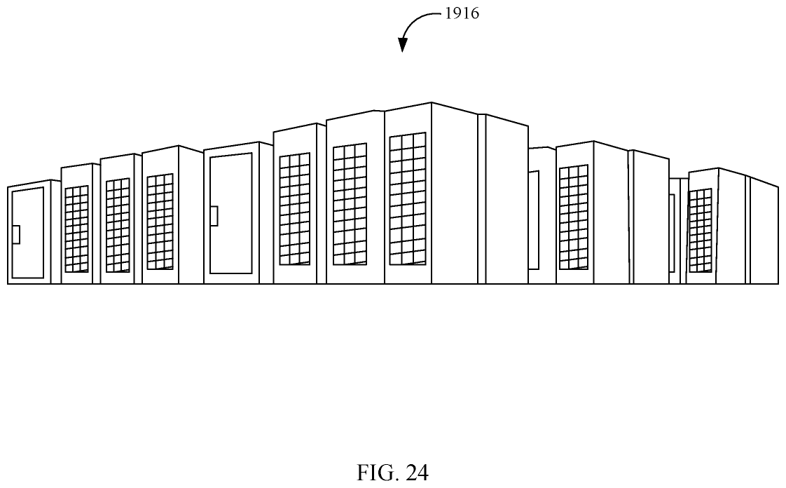

FIG. 24 is a perspective view of the battery power storage system 1916, in accordance with some embodiments.

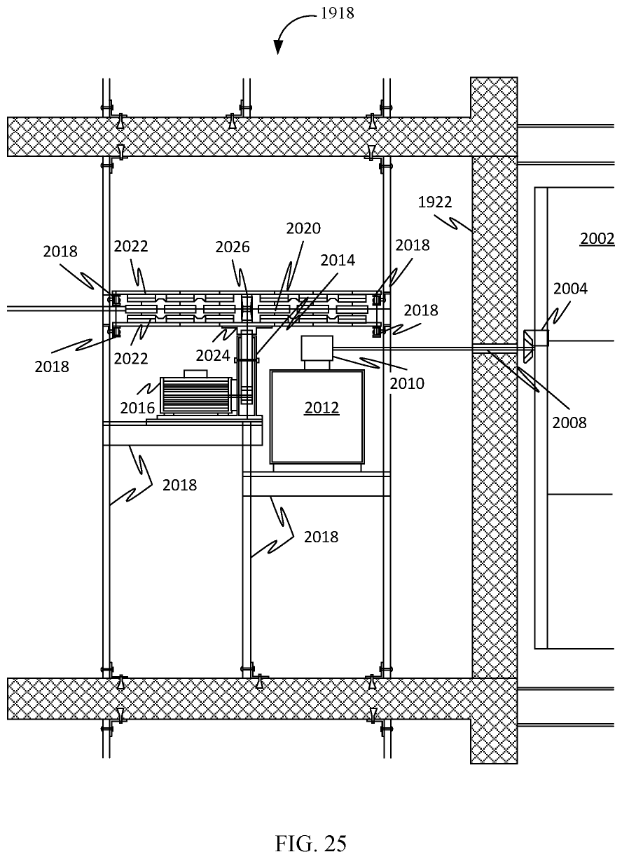

FIG. 25 is a cross-sectional view of the power production generator assembly 1918, in accordance with some embodiments.

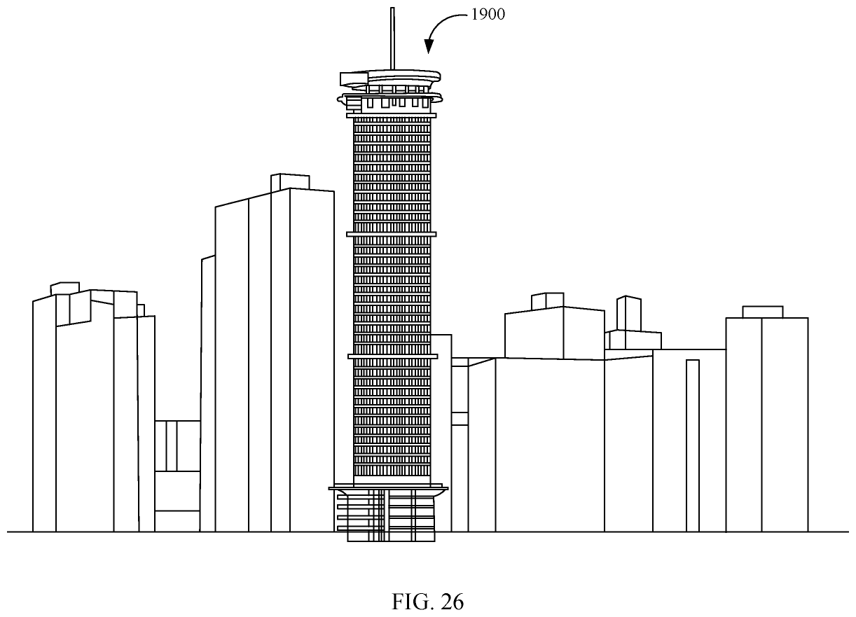

FIG. 26 is a front view of the wind-based power plant system 1900 in a city landscape, in accordance with some embodiments.

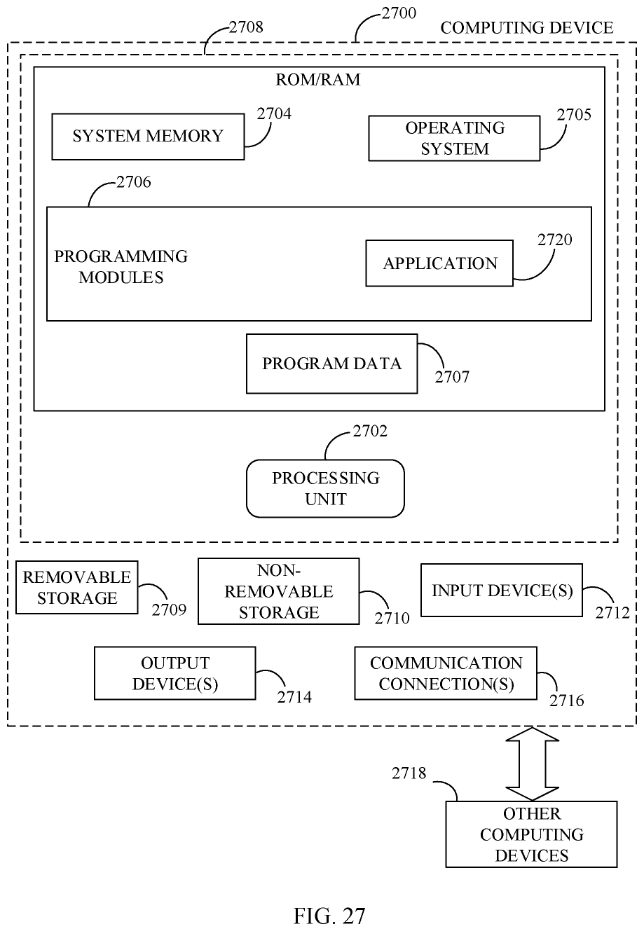

With reference to FIG. 27, a system consistent with an embodiment of the disclosure may include a computing device or cloud service, such as computing device 2700. In a basic configuration, computing device 2700 may include at least one processing unit 2702 and a system memory 2704. Depending on the configuration and type of computing device, system memory 2704 may comprise, but is not limited to, volatile (e.g. random-access memory (RAM)), non-volatile (e.g. read-only memory (ROM)), flash memory, or any combination. System memory 2704 may include operating system 2705, one or more programming modules 2706, and may include a program data 2707. Operating system 2705, for example, may be suitable for controlling computing device 2700′s operation. Furthermore, embodiments of the disclosure may be practiced in conjunction with a graphics library, other operating systems, or any other application program and is not limited to any particular application or system. This basic configuration is illustrated in FIG. 27 by those components within a dashed line 2708.

Computing device 2700 may have additional features or functionality. For example, computing device 2700 may also include additional data storage devices (removable and/or non-removable) such as, for example, magnetic disks, optical disks, or tape. Such additional storage is illustrated in FIG. 27 by a removable storage 2709 and a non-removable storage 2710. Computer storage media may include volatile and non-volatile, removable and non-removable media implemented in any method or technology for storage of information, such as computer-readable instructions, data structures, program modules, or other data. System memory 2704, removable storage 2709, and non-removable storage 2710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2700. Any such computer storage media may be part of device 2700. Computing device 2700 may also have input device(s) 2712 such as a keyboard, a mouse, a pen, a sound input device, a touch input device, a location sensor, a camera, a biometric sensor, etc. Output device(s) 2714 such as a display, speakers, a printer, etc. may also be included. The aforementioned devices are examples and others may be used.

Computing device 2700 may also contain a communication connection 2716 that may allow device 2700 to communicate with other computing devices 2718, such as over a network in a distributed computing environment, for example, an intranet or the Internet. Communication connection 2716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2704, including operating system 2705. While executing on processing unit 2702, programming modules 2706 may perform processes including, for example, one or more stages of methods, algorithms, systems, applications, servers, databases as described above. The aforementioned process is an example, and processing unit 2702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A wind-based power plant system for providing an electrical power to an electrical load, the wind-based power plant system comprising:
a building structure vertically erectable on a surface, wherein the building structure comprises at least one housing structure, wherein the at least one housing structure is vertically stacked for forming the building structure;
at least one wind directing assembly disposed in the at least one housing structure, wherein a wind directing assembly of the at least one wind directing assembly disposed in a housing structure of the at least one housing structure is configured for allowing entering of wind in the housing structure from a first side of the housing structure, wherein the wind directing assembly is configured for allowing exiting of the wind from a second side of the housing structure, wherein the wind directing assembly is configured for at least one of controlling and creating a flow of the wind based on at least one of the allowing entering of the wind and the allowing exiting of the wind, wherein the wind directing assembly is transitionable between a plurality of wind directing states of the wind directing assembly for the at least one of the allowing entering of the wind and the allowing exiting of the wind, wherein the wind directing assembly comprises:
at least one wind sensor disposed in the housing structure, wherein the at least one wind sensor is configured for generating at least one wind data based on at least one of a direction of the wind and a velocity of the wind associated with the housing structure;
a processing device communicatively coupled with the at least one wind sensor, wherein the processing device is configured for:
analyzing the at least one wind data; and
generating a command based on the analyzing; and
at least one actuator disposed in the housing structure, wherein the at least one actuator is operationally coupled with the wind directing assembly, wherein the at least one actuator is communicatively coupled with the processing device, wherein the at least one actuator is configured for transitioning the wind directing assembly between the plurality of wind directing states of the wind directing assembly based on the command;
at least one turbine blade assembly disposed in the at least one housing structure, wherein a turbine blade assembly of the at least one turbine blade assembly disposed in the housing structure comprises a plurality of wind turbine blades arranged radially around a vertical axis of the building structure in the housing structure, wherein the plurality of wind turbine blades is configured for intercepting the flow of the wind, wherein the plurality of wind turbine blades is configured for rotating around the vertical axis based on the intercepting; and
at least one electrical generator disposed in the at least one housing structure, wherein the at least one electrical generator is mechanically coupled with the at least one turbine blade assembly, wherein an electrical generator of the at least one electrical generator disposed in the housing structure is configured for generating the electrical power based on the rotating, wherein the at least one electrical generator is electrically couplable to the electrical load for providing the electrical power to the electrical load.

2. The wind-based power plant system of claim 1, wherein the wind directing assembly comprises a wind vane assembly, wherein the wind vane assembly comprises a plurality of wind vanes, wherein the plurality of wind vanes is peripherally disposed around a housing structure periphery of the housing structure, wherein the plurality of wind directing states corresponds to a plurality of vane positions of a wind vane of the plurality of wind vanes about at least one of a horizontal vane axis of the wind vane and a vertical vane axis of the wind vane, wherein the plurality of wind vanes is transitionable between the plurality of vane positions forming a first openably closable opening on the first side and a second opneably closable opening on the second side for the allowing entering of the wind and the allowing exiting of the wind.

3. The wind-based power plant system of claim 1, wherein the wind directing assembly comprises a wind funnel intake ring, wherein the wind funnel intake ring is peripherally disposed around a housing structure periphery of the housing structure, wherein the wind funnel intake ring comprises a funnel portion and a tail portion, wherein the funnel portion comprises a funnel opening corresponding to the first side and the tail portion comprises a tail opening corresponding to the second side, wherein the funnel portion increases the velocity of the wind entering the funnel opening and exiting the tail opening based on a wind tunnel effect, wherein the plurality of wind directing states corresponds to a plurality of funnel intake ring positions about the vertical axis, wherein the wind funnel intake ring is rotatable around the vertical axis for transitioning between the plurality of funnel intake ring positions.

4. The wind-based power plant system of claim 3, wherein the wind funnel intake ring comprises a slidable door disposed in the funnel portion of the wind funnel intake ring, wherein the slidable door is slidable between a plurality of sliding positions for opneably closing the funnel opening, wherein the plurality of wind directing states corresponds to the plurality of sliding positions.

5. The wind-based power plant system of claim 1, wherein the turbine blade assembly comprises a plurality of support rails disposed in the housing structure, wherein the plurality of support rails is configured for supporting the plurality of wind turbine blades, wherein the plurality of support rails forms a plurality of tracks, wherein the plurality of wind turbine blades contactably moves on the plurality of tracks based on the rotating.

6. The wind-based power plant system of claim 1 further comprising a power storage system electrically coupled with the at least one electrical generator, wherein the power storage system comprises at least one battery, wherein the at least one battery is configured for receiving the electrical power from the at least one electrical generator, wherein the at least one battery stores the electrical power based on the receiving, wherein the electrical power comprises a DC electrical power, wherein the power storage system is electrically couplable to the electrical load for providing the electrical power to the electrical load.

7. The wind-based power plant system of claim 6, wherein the power storage system comprises at least one battery charging assembly, wherein the at least one battery is removably disposed in the at least one housing structure, wherein the at least one battery charging assembly is configured for detachably connecting the at least one battery to the at least one electrical generator, wherein the at least one battery charging assembly transitions between a connected state and a disconnected state based on the detachably connecting, wherein the at least one battery receives the electrical power in the connected state, wherein the at least one battery does not receive the electrical power in the disconnected state.

8. The wind-based power plant system of claim 6 further comprising at least one sensor disposed in the housing structure, wherein the at least one sensor is communicatively coupled with the processing device, wherein the at least one sensor is configured for generating at least one battery data based on a charge level of the at least one battery, wherein the processing device is further configured for:
analyzing the at least one battery data based on a predetermined range of the charge level; and
generating a sixth command based on the analyzing of the at least one battery data, wherein the at least one actuator is further configured for transitioning the wind directing assembly between the plurality of wind directing states of the wind directing assembly based on the sixth command.

9. The wind-based power plant system of claim 6 further comprising at least one power production generator assembly disposed in the at least one housing structure, wherein a power production generator assembly of the at least one power production generator assembly disposed in the housing structure comprises:
two rotor assemblies comprising a top rotor assembly and a bottom rotor assembly, wherein the top rotor assembly comprises a top rotor platform and a plurality of top rotor magnets disposed on a first surface of the top rotor platform, wherein the plurality of top rotor magnets is arranged in an alternating polarity of the plurality of top rotor magnets, wherein the bottom rotor assembly comprises a bottom rotor platform and a plurality of bottom rotor magnets disposed on a second surface of the bottom rotor platform, wherein the plurality of bottom rotor magnets is arranged in an alternating polarity of the plurality of bottom rotor magnets, wherein the second surface opposes the first surface;
a stator assembly disposed between the two rotor assemblies, wherein the stator assembly is adjacent to each of the first surface and the second surface, wherein the stator assembly comprises a stator platform and a plurality of windings disposed on the stator platform, wherein the plurality of windings corresponds to the plurality of top rotor magnets and the plurality of bottom rotor magnets;
at least one power production generator motor electrically coupled with the power storage system, wherein the at least one power production generator motor is mechanically coupled with the two rotor assemblies, wherein the at least one power production generator motor is configured for:
receiving the electrical power from the at least one battery; and
rotating the two rotor assemblies in relation to the stator assembly around the vertical axis based on the receiving of the electrical power, wherein the at least one power production generator assembly is configured for generating the electrical power based on the rotating of the two rotor assemblies, wherein the electrical power is an AC electrical power, wherein the at least one power production generator assembly is electrically couplable to the electrical load for providing the electrical power to the electrical load.

10. The wind-based power plant system of claim 9, wherein the at least one power production generator motor is configured for rotating the top rotor assembly and the bottom rotor assembly in relation to the stator assembly around the vertical axis in opposite directions, wherein a first direction of the rotating of the top rotor assembly is opposite to a second direction of the rotating of the bottom rotor assembly.

11. The wind-based power plant system of claim 9, wherein the at least one power production generator motor is configured for rotating the top rotor assembly and the bottom rotor assembly in relation to the stator assembly around the vertical axis in similar directions, wherein a first direction of the rotating of the top rotor assembly is similar to a second direction of the rotating of the bottom rotor assembly.

12. The wind-based power plant system of claim 1 further comprising at least one velocity sensor disposed on the turbine blade assembly, wherein the at least one velocity sensor is communicatively coupled with the processing device, wherein the at least one velocity sensor is configured for generating at least one velocity data based on a velocity of the plurality of wind turbine blades, wherein the processing device is further configured for:
analyzing the at least one velocity data based on a predetermined range of the velocity of the plurality of wind turbine blades; and
generating a first command based on the analyzing of the at least one velocity data, wherein the at least one actuator is further configured for transitioning the wind directing assembly between the plurality of wind directing states based on the first command.

13. The wind-based power plant system of claim 1 further comprising at least one electrical power measuring device electrically coupled with the electrical generator, wherein the at least one electrical power measuring device is communicatively coupled with the processing device, wherein the at least one electrical power measuring device is configured for generating at least one measurement data based on measuring at least one value of at least one electrical parameter of the electrical power, wherein the processing device is further configured for:
analyzing the at least one measurement data based on a predetermined range of the at least one value of the at least one electrical parameter of the electrical power; and
generating a second command based on the analyzing of the at least one measurement data, wherein the at least one actuator is further configured for transitioning the wind directing assembly between the plurality of wind directing states of the wind directing assembly based on the second command.

14. The wind-based power plant system of claim 1 further comprising a turbine velocity control system disposed in the at least one housing structure, wherein the turbine velocity control system is coupled with the at least one turbine blade assembly, wherein the turbine velocity control system comprises:
at least one first velocity sensor configured for generating at least one first velocity data based on a velocity of the plurality of wind turbine blades;
a first processing device communicatively coupled with the at least one first velocity sensor, wherein the first processing device is configured for:
analyzing the at least one first velocity data based on a predetermined range of the velocity of the plurality of wind turbine blades; and
generating a third command based on the analyzing of the at least one first velocity data; and
at least one turbine actuator communicatively coupled with the first processing device, wherein the at least one turbine actuator is operationally coupled with the at least one turbine blade assembly, wherein the at least one turbine actuator is configured for modifying the velocity of the plurality of wind turbine blades based on the third command.

15. The wind-based power plant system of claim 1 further comprising at least one environment sensor disposed in the housing structure, wherein the at least one environment sensor is communicatively coupled with the processing device, wherein the at least one environment sensor is configured for generating at least one environment data based on an environment of the building structure, wherein the processing device is further configured for:
analyzing the at least one environment data;
determining at least one environmental condition of the environment based on the analyzing of the at least one environment data; and
generating a fourth command based on the determining, wherein the at least one actuator is further configured for transitioning the wind directing assembly between the plurality of wind directing states of the wind directing assembly based on the fourth command.

16. The wind-based power plant system of claim 1 further comprising at least one measuring device electrically couplable to the electrical load, wherein the at least one measuring device is communicatively coupled with the processing device, wherein the at least one measuring device is configured for:
measuring an electrical power demand associated with the electrical load; and
generating at least one electrical power demand data based on the measuring, wherein the processing device is further configured for:
analyzing the at least one electrical power demand data; and
generating a fifth command based on the analyzing of the at least one electrical power demand data, wherein the at least one actuator is further configured for transitioning the wind directing assembly between the plurality of wind directing states of the wind directing assembly based on the fifth command.

17. A wind-based power plant system for providing an electrical power to an electrical load, the wind-based power plant system comprising:
a building structure vertically erectable on a surface, wherein the building structure comprises at least one housing structure, wherein the at least one housing structure is vertically stacked forming the building structure;
at least one wind directing assembly disposed in the at least one housing structure, wherein a wind directing assembly of the at least one wind directing assembly disposed in a housing structure of the at least one housing structure is configured for allowing entering of wind in the housing structure from a first side of the housing structure, wherein the wind directing assembly is configured for allowing exiting of the wind from a second side of the housing structure, wherein the wind directing assembly is configured for at least one of controlling and creating a flow of the wind based on at least one of the allowing entering of the wind and the allowing exiting of the wind, wherein the wind directing assembly is transitionable between a plurality of wind directing states of the wind directing assembly for the at least one of the allowing entering of the wind and the allowing exiting of the wind, wherein the wind directing assembly comprises:
at least one wind sensor disposed in the housing structure, wherein the at least one wind sensor is configured for generating at least one wind data based on at least one of a direction of the wind and a velocity of the wind associated with the housing structure;
a processing device communicatively coupled with the at least one wind sensor, wherein the processing device is configured for:
analyzing the at least one wind data; and
generating a command based on the analyzing; and
at least one actuator disposed in the housing structure, wherein the at least one actuator is operationally coupled with the wind directing assembly, wherein the at least one actuator is communicatively coupled with the processing device, wherein the at least one actuator is configured for transitioning the wind directing assembly between the plurality of wind directing states of the wind directing assembly based on the command;
at least one turbine blade assembly disposed in the at least one housing structure, wherein a turbine blade assembly of the at least one turbine blade assembly disposed in the housing structure comprises a plurality of wind turbine blades arranged radially around a vertical axis of the building structure in the housing structure, wherein the plurality of wind turbine blades is configured for intercepting the flow of the wind, wherein the plurality of wind turbine blades is configured for rotating around the vertical axis based on the intercepting;
at least one electrical generator disposed in the at least one housing structure, wherein the at least one electrical generator is mechanically coupled with the at least one turbine blade assembly, wherein an electrical generator of the at least one electrical generator disposed in the housing structure is configured for generating the electrical power based on the rotating, wherein the at least one electrical generator is electrically couplable to the electrical load for providing the electrical power to the electrical load; and
a power storage system electrically coupled with the at least one electrical generator, wherein the power storage system comprises at least one battery, wherein the at least one battery is configured for receiving the electrical power from the at least one electrical generator, wherein the at least one battery stores the electrical power based on the receiving, wherein the electrical power comprises a DC electrical power, wherein the power storage system is electrically couplable to the electrical load for providing the electrical power to the electrical load.

18. The wind-based power plant system of claim 17, wherein the wind directing assembly comprises a wind vane assembly, wherein the wind vane assembly comprises a plurality of wind vanes, wherein the plurality of wind vanes is peripherally disposed around a housing structure periphery of the housing structure, wherein the plurality of wind directing states corresponds to a plurality of vane positions of a wind vane of the plurality of wind vanes about at least one of a horizontal vane axis of the wind vane and a vertical vane axis of the wind vane, wherein the plurality of wind vanes is transitionable between the plurality of vane positions forming a first openably closable opening on the first side and a second opneably closable opening on the second side for the allowing entering of the wind and the allowing exiting of the wind.

19. The wind-based power plant system of claim 17, wherein the wind directing assembly comprises a wind funnel intake ring, wherein the wind funnel intake ring is peripherally disposed around a housing structure periphery of the housing structure, wherein the wind funnel intake ring comprises a funnel portion and a tail portion, wherein the funnel portion comprises a funnel opening corresponding to the first side and the tail portion comprises a tail opening corresponding to the second side, wherein the funnel portion increases the velocity of the wind entering the funnel opening and exiting the tail opening based on a wind tunnel effect, wherein the plurality of wind directing states corresponds to a plurality of funnel intake ring positions about the vertical axis, wherein the wind funnel intake ring is rotatable around the vertical axis for transitioning between the plurality of funnel intake ring positions.

20. The wind-based power plant system of claim 17, wherein the power storage system comprises at least one battery charging assembly, wherein the at least one battery is removably disposed in the at least one housing structure, wherein the at least one battery charging assembly is configured for detachably connecting the at least one battery to the at least one electrical generator, wherein the at least one battery charging assembly transitions between a connected state and a disconnected state based on the detachably connecting, wherein the at least one battery receives the electrical power in the connected state, wherein the at least one battery does not receive the electrical power in the disconnected state.
